(19) United States
(12) Patent Application Publication
(10) Pub. No.: US 2021/0174642 A1
(43) Pub. Date: Jun. 10, 2021

(54) SYSTEMS FOR CONTINUOUS MULTIVARIATE WAGERING

(71) Applicant: Gamblit Gaming, LLC, Glendale, CA (US)

(72) Inventor: Edvard Toth, Santa Monica, CA (US)

(21) Appl. No.: 16/916,086

(22) Filed: Jun. 29, 2020

Related U.S. Application Data
(63) Continuation-in-part of application No. 16/877,428, filed on May 18, 2020, now abandoned.
(60) Provisional application No. 62/849,511, filed on May 17, 2019.
(60) Provisional application No. 62/889,538, filed on Aug. 20, 2019.
(60) Provisional application No. 62/867,854, filed on Jun. 27, 2019.

(51) Int. Cl. G07F 17/32; G07F 17/34

(52) U.S. Cl. CPC G07F 17/3267; G07F 17/34; G07F 17/3213

(57) ABSTRACT

Systems for continuous multivariate wagering process are disclosed. A continuous multivariate wagering electronic gaming system includes an interactive controller constructed to receive one or more stochastic elements of a multivariate wagering process from a process controller, generate an interactive user interface using the one or more stochastic elements, detect player interactions of a player with the interactive user interface, determine one or more interactive intermediate states of the continuous multivariate wagering process based on the player interactions and the one or more stochastic elements, and communicate the one or more interactive intermediate states to the process controller. The system further includes the process controller operatively connected to the interactive controller that includes a random number generator. The process controller is constructed to generate one or more stochastic components using the random number generator, generate the one or more stochastic elements using the one or more stochastic components, determine one or more chance-based intermediate states of the continuous multivariate wagering process, communicate the one or more stochastic elements to the interactive controller, receive the one or more interactive intermediate states from the interactive controller, and determine a wagering outcome for the continuous multivariate wagering process using the intermediate states.

### CROSS REFERENCE TO RELATED APPLICATION

This application is a continuation in part of U.S. application Ser. No., 16/877,428 filed, May 18, 2020, which claims the benefit of U.S. Provisional Application No. 62/849,511, filed May 17, 2019, and this application claims the benefit of U.S. Provisional Application No., 62/867,854, filed, Jun. 27, 2020, and U.S. Provisional Application No. 62/889,538, filed Aug. 20, 2019, the contents of each of which are incorporated by reference herein.

### FIELD OF THE INVENTION

Embodiments of the invention are generally related to data processing systems. More particularly, embodiments of the invention relate to data processing systems that perform processes for multivariate wagering.

### BACKGROUND

The gambling industry has developed simple gambling games that are implementable on simple gaming devices and systems. For example, U.S. Pat. No. 6,905,405 to McClintic describes a simple gaming device provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Such a simple gaming device is capable of implementing a mechanical 3-reel slot machine having 22 possible positions or symbols on each reel. In such a simple game, there are 22\hat{ }3, or 10,648, possible pays based on the combinations of the reel positions. Each time the slot machine is played, a single pay is determined from randomly spinning the mechanical reels. If a 3-reel slot machine is implemented on a simple gaming device having virtual video reels, each possible pay is explicitly enumerated in a table that is used to determine a pay as well as determine an animation sequence for the video virtual reels that corresponds to the pay. Such a table will have at least 10,648 locations, one position for each possible combination of the 3 reels, with each location representing a pay and a representation of the stopped position of the 3 reels. If digital storage of each pay requires 8 bytes of storage, the table can be stored in approximately 83 kilobytes of digital memory (8 bytes of data for each pay and reel animation identifier×10,648 possible pays/1024 Bytes per kilobyte). In operation, a single random number is determined, and that random number is used as an index into the table to select a pay and reel animation identifier from the 10,648 possible pays and reel animations. Accordingly, approximately 83 kilobytes of memory is needed to store all of the enumerated pay and reel animations of a simple slot machine game having approximately 10 thousand pay and reel animations on a simple gaming device.

Operation of another simple gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

In the simple gaming system, all images of the wagering game are generated on the server/host and then all of the images are transferred to the client/terminal. This limits the complexity of the interactions by the player with a wagering game hosted by the server/host because of the time required to communicate the images between the server/host and as well as network lag in requesting the transfer of the images.

Accordingly, simple gaming devices and systems are not capable of implementing complex multivariate wagering processes. Various aspects and embodiments of the invention meet such a need.

### SUMMARY

Systems and methods in accordance with embodiments of the invention detect and process multivariate stochastic events in order to perform a continuous multivariate wagering process.

In an embodiment, a continuous multivariate wagering electronic gaming machine includes an interactive controller constructed to receive one or more stochastic elements of a multivariate wagering process from a process controller, generate an interactive user interface using the one or more stochastic elements, detect player interactions of a player with the interactive user interface, determine one or more interactive intermediate states of the continuous multivariate wagering process based on the player interactions and the one or more stochastic elements, and communicate the one or more interactive intermediate states to the process controller. The continuous multivariate wagering electronic gaming machine further includes the process controller operatively connected to the interactive controller, wherein the process controller includes a random number generator, and wherein the process controller is constructed to generate one or more stochastic components using the random number generator, generate the one or more stochastic elements using the one or more stochastic components, determine one or more chance-based intermediate states of the continuous multivariate wagering process, communicate the one or more stochastic elements to the interactive controller, receive the one or more interactive intermediate states from the interactive controller, and determine a wagering outcome for the continuous multivariate wagering process using the intermediate states.

### BRIEF DESCRIPTION OF THE DRAWINGS

FIG. 1 illustrates a state diagram, a multidimensional process space diagram, and a user interface block diagram of a continuous multivariate wagering system for performing a continuous multivariate wagering process in accordance with various embodiments of the invention.

FIG. 2 is a diagram of a structure of a continuous multivariate wagering system for performing a continuous multivariate wagering process in accordance with various embodiments of the invention.

FIG. 3A is a diagram of an electronic gaming machine configuration of a continuous multivariate wagering system for performing a continuous multivariate wagering process in accordance with various embodiments of the invention.

FIG. 3B is a diagram of a table electronic gaming machine configuration of a continuous multivariate wagering system for performing a continuous multivariate wagering process in accordance with various embodiments of the invention.

FIG. 3C is a diagram of a virtual reality gaming machine configuration of a continuous multivariate wagering system for performing a continuous multivariate wagering process in accordance with various embodiments of the invention.

FIG. 4 is a diagram of distributed continuous multivariate wagering system for performing a continuous multivariate wagering process in accordance with various embodiments of the invention.

FIGS. 5A and 5B are diagrams of a structure of an interactive controller of a continuous multivariate wagering system for performing a continuous multivariate wagering process in accordance with various embodiments of the invention.

FIG. 6 is a diagram of a structure of a process controller of a continuous multivariate wagering system for performing a continuous multivariate wagering process in accordance with various embodiments of the invention.

FIG. 7 is an activity diagram illustrating a process of a continuous multivariate wagering process performed by a continuous multivariate wagering system in accordance with various embodiments of the invention.

FIGS. 8A and 8B are sequence diagrams illustrating a process of a continuous multivariate wagering process performed by a continuous multivariate wagering system in accordance with various embodiments of the invention.

FIG. 9 is a block diagram illustrating a process of a continuous multivariate wagering system in accordance with various embodiments of the invention.

FIG. 10 is a state diagram illustrating a process of a continuous multivariate wagering process performed by a continuous multivariate wagering system in accordance with various embodiments of the invention.

FIGS. 11A and 11B are activity diagrams illustrating a process of a continuous multivariate wagering process performed by a continuous multivariate wagering system in accordance with various embodiments of the invention.

FIGS. 12A to 12C illustrate a user interface of a continuous multivariate wagering system in accordance with various embodiments of the invention.

FIG. 13 is an activity diagram illustrating a process of a continuous multivariate wagering process performed by a continuous multivariate wagering system in accordance with various embodiments of the invention.

FIGS. 14A to 14D illustrate a user interface of a continuous multivariate wagering system in accordance with various embodiments of the invention.

FIG. 15 is another state diagram illustrating another process of a system for continuous multivariate wagering in accordance with various embodiments of the invention.

FIG. 16 is another activity diagram illustrating another process of a system for continuous multivariate wagering in accordance with various embodiments of the invention.

FIG. 17A to 17D illustrate a user interface of a system for continuous multivariate wagering in accordance with various embodiments of the invention.

### DETAILED DESCRIPTION

A multivariate wagering session in accordance with various embodiments of the invention includes determining by a continuous multivariate wagering system a wagering outcome for a wager committed by a player during one or more continuous multivariate wagering processes.

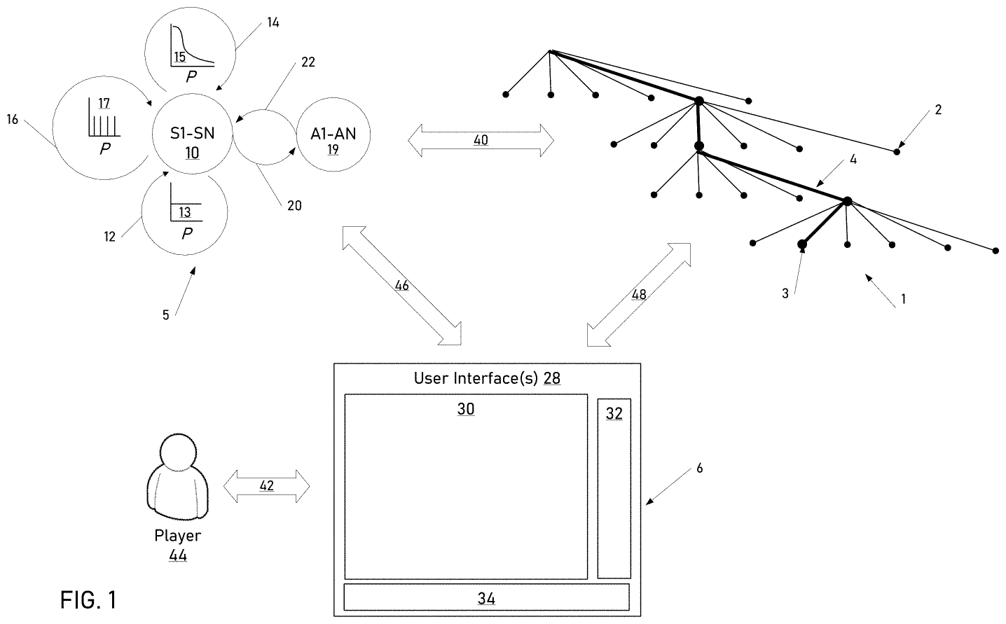

FIG. 1 illustrates a state diagram 5 of a state machine, a multidimensional process space diagram 1, and a user interface block diagram 6 of a multivariate wagering system for performing a multivariate wagering process in accordance with various embodiments of the invention. A multidimensional process space diagram, illustrated herein using a tree diagram 1, illustrates a process space of a multivariate wagering process in accordance with various embodiments of the invention. The process space of a multivariate wagering process can be modeled using a multidimensional process space or manifold where each dimension of the manifold is associated with one or more variables of one or more stochastic events of a multivariate wagering process. A multivariate wagering process has multiple states within the multidimensional process space, herein represented by nodes in the tree diagram. Some of the states are intermediate states, such as state 2, of a multivariate wagering process and some of the states, such as state 3, are award states representing wager outcomes of a multivariate wagering process. A traversal of the multidimensional process space, such as traversal 4, can be used to model a multivariate wagering process.

FIG. 1 also includes a state diagram 5 of a state machine of a multivariate wagering system that performs a multivariate wagering process in accordance with various embodiments of the invention. A traversal 4 of the multivariate process space 1 of a multivariate wagering process can be preformed by the state machine 5 having a set of one or more intermediate states, such as intermediate states S1 to state SN 10, and one or more award states, such as award states A1 to state AN 19. A transition between some of the states may occur in response to nondeterministic stochastic events during a multivariate wagering process, such a transition is herein termed a stochastic transition. Different types and different combinations of types of stochastic events cause stochastic transitions between states of a multivariate wagering process.

The set of states of the state machine are encompassed by the process space 1 of a multivariate wagering process and the state machine performs a traversal 4 of the process space 1 during a multivariate wagering process as indicated by double headed arrow 40.

In many embodiments, one or more stochastic transitions are made by the multivariate wagering system during a multivariate wagering process as a result of a stochastic event generated by a multivariate wagering system, such as stochastic transition 12, where the probability that the stochastic event is generated has a probability distribution 13. A stochastic event generated by a multivariate wagering system is herein termed a system stochastic event and a state associated with a system stochastic event is herein termed a system intermediate state.

In some embodiments, one or more stochastic transitions occur based on detection by a multivariate wagering system of a player's interaction with a multivariate wagering process, such as stochastic transition 14. The stochastic transition is based upon detection by a multivariate wagering system of an interaction by a player with an interactive element of a user interface of a multivariate wagering system. The probability that a player will interact with the interactive element to effect a particular stochastic transition may be described using a probability distribution 15 for the player interaction. A stochastic event resulting from detection by a multivariate wagering system of a player interaction is herein termed an interactive stochastic event and intermediate state associated with detecting an interactive stochastic event is herein termed an interactive intermediate state.

In various embodiments, a stochastic transition occurs as a result of detecting a player's selection made between two or more selectable interactive elements, as exemplified by stochastic transition 16 having a discrete probability distribution 17.

A multivariate wagering process may also include one or more award states, such as award states A1 to AN 19. Each award state represents an award of value awarded to a player. When A multivariate wagering process transitions 20 to an award state an award is awarded to a player by a multivariate wagering system performing the multivariate wagering process. In some embodiments, a multivariate wagering process transitions 22 from an award state back to an intermediate state for further multivariate wager processing.

FIG. 1 also includes a block diagram 6 illustrating a user interface and display of a multivariate wagering system in accordance with various embodiments of the invention. A multivariate wagering system includes one or more user interfaces 28 that are used to display to a player 44 an interactive presentation generated by a multivariate wagering system based on the state machine 5 (as indicated by double arrow 46) and based on the traversal 4 of the process space 1 (as indicated by double arrow 48) of a multivariate wagering process performed by a multivariate wagering system. The one or more user interfaces 28 are also used by a multivariate wagering system to detect player interactions 42 with the interactive presentation.

The one or more user interfaces 28 include one or more interactive user interface portions 30 having a display used by a multivariate wagering system to display to a player interactive objects that the player interacts with and to detect user interactions with the interactive objects during a multivariate wagering process. In many embodiments, the one or more user interfaces also include one or more wagering user interface portions 34 having a display used by a multivariate wagering system to display to a player a state of a multivariate interactive wagering process and detect player interactions with the wagering user interface. In many embodiments, the one or more wagering user interfaces also include one or more wager process user interface portions 32 having a display used by a multivariate wagering system to display to a player a stochastic element generation process such as, but not limited to, a generation process of one or more chance-based outcomes.

By utilizing the one or more user interfaces 28 and associated displays, a multivariate wagering system can integrate interactive stochastic events, system stochastic events, intermediate states, and award states of a process space of a multivariate wagering process into a user interface and communicate a state of a multivariate wagering process to the player all the while executing a multivariate wagering process seamlessly from the player's perspective.

Some embodiments of multivariate wagering processes have sets of intermediate states and award states whose sizes are many orders of magnitude larger than a set of pays of a simple slot machine game. In an example embodiment, a multivariate wagering process incudes a display where selectable chance-based outcomes are displayed to a player as a set of possible award states. The display includes 9 locations with each location having twenty-two possible chance-based outcomes. Such a multivariate wagering process display has 1,207,269,217,792, or over 1.2 trillion, possible award states. If 8 bytes of digital memory are used to store each award state, then a complete enumeration of all of award states, as required using simple gaming devices, would require 9.6 terabytes of memory storage. However, utilization a multivariate wagering system and multivariate wagering processes as described herein reduces the storage memory requirement of a multivariate wagering process. This reduction in memory requirement reduces the amount of physical and/or virtual memory needed to implement a multivariate wagering process, and also may reduce an amount of time needed to generate a multivariate wagering process display.

In another example embodiment, a multivariate wagering process has a process space with 17 dimensions and approximately 1,576,418,005,371,090,000,000, or over 1.5 sextillion possible intermediate states and award states. Enumeration and storage of the set of states for implementation of such a multivariate wagering process on a simple electronic gaming machine would require over 12.6 zettabytes of addressable memory storage. Furthermore, if it took only 1 billionth of a second to enumerate each state, it would take almost 50,000 years to enumerate the complete set of states. Accordingly, some multivariate wagering processes are simply not implementable using simple electronic gaming machines. However, multivariate wagering processes having large sets of states may be implemented on various embodiments of a multivariate wagering system.

In some embodiments, the continuous multivariate wagering system's user interfaces and associated displays allow transparent coupling of an interactive game to wagering propositions, providing a seamless perspective to the player that they are playing an interactive game such as, but not limited to, a video game. In accordance with some embodiments, a multivariate wagering system can be used to enable a wide range of interactive video games including but not limited to popular titles from arcade and home video games.

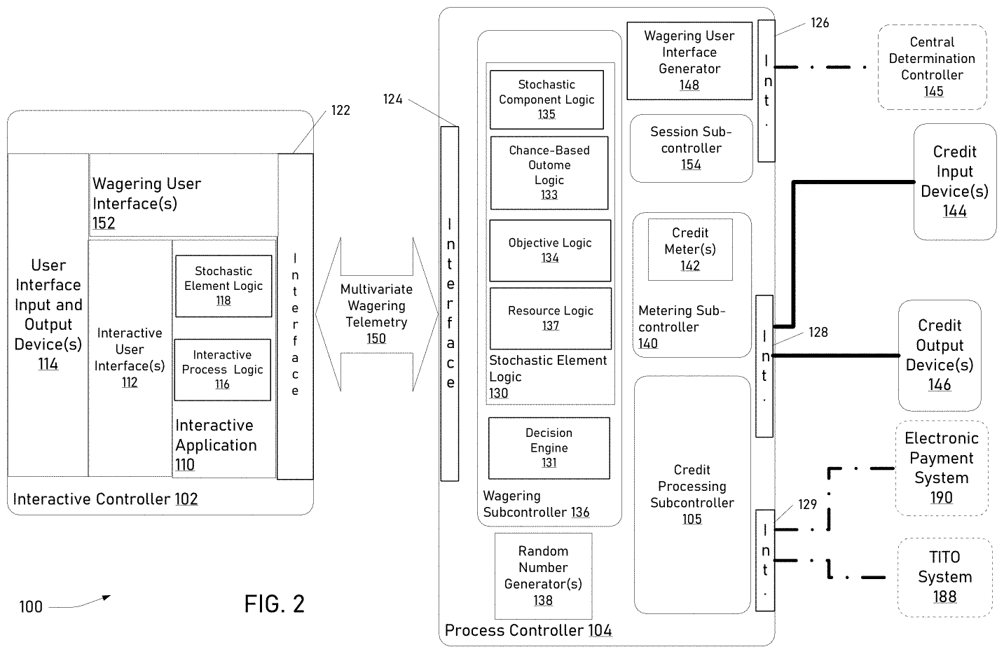

FIG. 2 is a diagram of an architecture of a continuous multivariate wagering system in accordance with various embodiments of the invention. The continuous multivariate wagering system is designed to implement a multivariate wagering process through the initiation, detection, and processing of stochastic events. The continuous multivariate wagering system 100 includes an interactive controller 102 and a process controller 104. The process controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the interactive controller 102 detects player interactions with a multivariate wagering process implemented by a continuous multivariate wagering system. The interactive controller 102 executes an interactive application 110 and provides one or more user interface user input and output devices 114 so that one or more players can interact with the interactive application 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, ear buds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an interactive user interface 112 that utilizes the user input devices to detect player interactions with interactive elements of the interactive application 110 of the interactive controller 102 and generates an interactive user interface that is presented to the player utilizing the user output devices.

In some embodiments, one or more components of an interactive controller are housed in an enclosure such as a housing, cabinet, casing or the like. The enclosure further includes one or more player accessible openings or surfaces constructed to mount the user input devices and/or the user output devices.

The interactive controller 102 is operatively connected to, and communicates with, the process controller 104. The interactive controller 102 receives application resource data, as part of wagering telemetry data, including but not limited to, stochastic element data from the process controller 104.

In some embodiments, during execution of the interactive application 110 by the interactive controller 102, the interactive controller 102 communicates, as part of wagering telemetry data 150, detected player interactions with one or more interactive elements of the interactive user interfaces 112 of the interactive application, to the process controller 104. The multivariate wagering telemetry data may include, but is not limited to, interactive application variables that indicate the state of the interactive application 110, interactive controller data indicating a status of the interactive controller 102, detected player actions and interactions between one or more players and the interactive application 110, one or more intermediate states of and/or one or more award states based on the detected player interactions with interactive elements of the interactive application 110, and utilization of interactive elements of the interactive application 110 by one or more players.

In many embodiments, the interactive application 110 includes stochastic element logic 118 utilized by the interactive application to generate one or more in-application resources and/or interactive elements in accordance with stochastic element data received from the process controller 104 included in the wagering telemetry data 150.

The interactive application 110 determines one or more award states based on detection of the interactions of the one or more players with interactive elements of the interactive application and communicates data of the determined award states to the process controller 104 as part of the multivariate wagering telemetry 150. In some embodiments, the interactive application 110 also communicates as part of the multivariate wagering telemetry data 150, data encoding the one or more players' interactions with the interactive application 110 and stochastic event data of stochastic events detected by the interactive application 110.

In some embodiments, the interactive application 110 is a skill-based interactive application, such as but not limited to a skill-based game. In embodiments, during execution of the skill-based interactive application 110 by the interactive controller 102, the interactive controller 102 detects the players' skillful interaction with interactive elements of the interactive application 110 during the players' skillful interaction with the skill-based interactive application 110 to achieve an objective of the skill-based game. The process controller 104 communicates with the interactive controller 102 in order to allow the coupling of the skill-based interactive application to stochastic elements generated in accordance with a multivariate wagering process implemented by the process controller 104 and/or the interactive controller 102.

In various embodiments, a continuous multivariate wagering system can include an interactive application 110 that provides for player versus player (PvP) competitive play between a single player and a computing device, between two or more players against one another, or multiple players playing against a computing device and/or each other. In embodiments, stochastic elements of a multivariate wagering process may be interjected into the competitive play to either enhance or disrupt one or more players' competitive play of the interactive application 110.

In some embodiments, the stochastic element logic 118 is communicated to the interactive controller 102 by the process controller 104 as part of the wagering telemetry data 150.

In some embodiments, the interactive controller 102 includes one or more sensors (not shown) that sense various aspects of the physical environment of the interactive controller 102. Examples of sensors include, but are not limited to: global positioning sensors (GPSs) for sensing communications from a GPS system to detect a position or location of the interactive controller; temperature sensors; accelerometers; pressure sensors; and the like. Sensor telemetry data detected from the one or more sensors are communicated by the interactive controller to the process controller 104 as part of the multivariate wagering telemetry data 150. The process controller 104 receives the sensor telemetry data and uses the sensor telemetry data along with stochastic element logic 118 to generate stochastic elements of a multivariate wagering process as described herein.

In many embodiments, the interactive controller 102 includes one or more wagering user interfaces 152 used to display wagering data, via one or more of the user interface input and output devices 114, to one or more players. The one or more wagering user interfaces include a display to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an application control interface 122 resident in the interactive controller 102 provides an interface between the interactive controller 102 and the process controller 104 via interface 124.

In some embodiments, interfaces 122 and 124 implement an interactive controller to process controller communication protocol employing an interprocess communication protocol so that an interactive controller and a process controller may be implemented on the same device. During a multivariate wagering process, the application control interface 122 provides application programming interfaces (APIs) that are used by an interactive application of the interactive controller to communicate outgoing data and receive incoming data by passing parameter data to another process or application.

In some embodiments, interfaces 122 and 124 implement an interactive controller to process controller communication protocol employing an interdevice communication protocol so that an interactive controller and a process controller may be implemented on different devices. The interdevice protocol may utilize a wired communication bus or wireless network as a physical layer.

In various embodiments, interfaces 122 and 124 implement an interactive controller to process controller communication protocol employing a networking protocol so that an interactive controller and a process controller may be implemented on different devices connected by a network. The networking protocol may utilize a wired communication bus or wireless network as a physical layer. In many embodiments, the network includes a cellular telephone network or the like and the interactive controller is a mobile device such as a smartphone, tablet computer or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the continuous multivariate wagering system.

In various embodiments, the process controller 104 includes a wagering subcontroller 136 that uses interactive stochastic element logic 118, and one or more random number generators 138 to initiate random number generation by the random number generators and generate stochastic elements used by the continuous multivariate wagering system to perform a multivariate wagering process.

In some embodiments, stochastic elements include, but are not limited to, stochastic components that are data values generated using one or more outputs of one or more random number generators 138 in accordance with stochastic component logic 135. In various embodiments, the stochastic components may be used in further processing by either the interactive controller 102 or the process controller 104 to generate one more additional stochastic elements.

In various embodiments, stochastic elements include, but are not limited to, chance-based outcomes that are an amount of credits or other items having value as described herein. The chance-based outcomes are generated in accordance with chance-based outcome logic 133 and one or more outputs from the one or more random number generators 138.

In many embodiments, stochastic elements include, but are not limited to, objectives of the multivariate wagering process that one or more players achieve when interacting with the interactive application 110 as described herein. The objectives are generated in accordance with objective logic 134 and one or more outputs from the one or more random number generators 138.

In various embodiments, stochastic elements include, but are not limited to, resources of an interactive application that a player uses and/or interacts with during interaction with the interactive application as described herein. The resources are generated in accordance with resource logic 137 and one or more outputs from the one or more random number generators 138.

In many embodiments, the wagering subcontroller 136 of the process controller 104 works in association with stochastic element logic 118 of the interactive application 110. In an example embodiment, the wagering subcontroller 136 uses an output of the one or more random number generators 138 along with the stochastic component logic 135 to generate a stochastic component. The stochastic component is then communicated to the interactive controller 102, and the interactive controller uses the stochastic element logic 118 to generate one or more application resources. In other example embodiments, the wagering subcontroller 136 uses the objective logic 134 to provide a selection of an objective that is generated by the interactive controller.

In several embodiments, a rule-based decision engine 131 uses the multivariate wagering telemetry data 150, one or more outputs of the one or more random number generators 138, along with stochastic element logic 118, to generate one or more stochastic elements as described herein. In embodiments, a decision engine 131 includes one or more rules as part of wager processing logic 130 used by a decision engine 131 to determine how a stochastic element should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more stochastic elements in accordance with the stochastic element logic 118 as described herein. During operation, the process controller 104 receives multivariate wagering telemetry data 150 from the interactive controller 102. The wagering subcontroller uses decision engine 131 to perform a matching process of matching the variable values encoded in the multivariate wagering telemetry data 150 to one or more variable patterns of one or more rules. If a match between the variable values and a pattern of a rule is detected, then the wagering subcontroller 136 performs the action of the matched rule.

In various embodiments, the process controller communicates data of one or more stochastic elements generated by the wagering subcontroller 136 to the interactive controller 102 as a portion of the application resource data communicated to the interactive controller 102.

In some embodiments, the decision engine 131 includes one or more rules as part of stochastic element logic 118 used by the decision engine to automatically generate the application resource data that is then communicated to the interactive controller 102.

In some embodiments, the interactive application 110 operates utilizing a scripting language. The interactive application 110 parses scripts written in the scripting language and executes commands encoded in the scripts. During a multivariate wagering process of some embodiments, the process controller 104 generates interactive application resource data in the form of scripts written in the scripting language that are communicated to the interactive controller 102 during execution of the interactive application 110. The interactive controller 102 receives the scripts and passes the m to the interactive application 110. The interactive application 110 receives the scripts, parses the scripts and automatically executes the commands as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. During a multivariate wagering process of some embodiments, the process controller 104 generates commands that are encoded into the application resource data communicated to the interactive controller 102. The interactive controller 102 passes the application resource data to the interactive application 110. The interactive application parses the application resource data and automatically performs operations in accordance with the commands encoded in the application resource data.

In many embodiments, the process controller 104 includes one or more interfaces, such as interface 126, that operatively connect the process controller 104 to one or more external devices used to generate chance-based outcomes, such as central determination controller 145. During a multivariate wagering process, when a wagering subcontroller 136 of the process controller 104 needs a chance-based outcome, the wagering subcontroller communicates a request to the central determination controller 145 for the chance-based outcome. The central determination controller 145 receives the chance-based outcome request and generates a chance-based outcome in response to the chance-based outcome request. The central determination controller communicates data of the chance-based outcome to the process controller 104. The process controller 104 receives the data of the chance-based outcome and utilizes the chance-based outcome as described herein. In some embodiments, the chance-based outcome is drawn from a pool of pre-generated chance-based outcomes.

In various embodiments, the central determination controller 145 is a progressive controller that is operatively connected to a plurality of continuous multivariate wagering systems (not shown). The progressive controller provides services for the collection and provision of credits used by the process controller 104 to provide wagering outcomes that have a progressive or pooling component.

In some embodiments, the process controller 104 includes one or more interfaces, such as interface 128, that operatively connect the process controller 104 to one or more credit input devices, such as credit input devices 144, and to one or more credit output devices, such as credit output devices 146.

In various embodiments, the process controller 104 includes one or more interfaces, such as interface 129, that operatively connect the process controller 104 to one or more ticket-in-ticket-out systems 188 and/or one or more electronic payment systems 190.

The process controller 104 manages one or more wagers in accordance with one or more multivariate wagering processes implemented by the continuous multivariate wagering system 100 by determining a commitment of a wager of value to the multivariate wagering process, executing the multivariate wagering process, and determining a wagering outcome of value of the multivariate wagering process. Types of value committed to the one or more wagers can be one or more of several different types. In various embodiments, types of value of a wager can include, but are not limited to, a wager of an amount of credits corresponding to a real currency or a virtual currency, a wager of an amount of application credits earned through interaction with an interactive application, a wager of an amount of interactive elements of an interactive application, and/or a wager of an amount of objects used in an interactive application. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of application credits earned through interaction with an interactive application, a wagering outcome of an amount of interactive elements of an interactive application, and a wagering outcome of an amount of in-application objects used in an interactive application.

In various embodiments, a type of value of a wagering outcome of a multivariate wagering process is different than a type of value of a wager commitment of the multivariate wagering process. In an example embodiment, a value of a wager commitment can be an amount of credits, and a value of a wagering outcome can be an in-application object of an interactive application.

In many embodiments, the process controller 104 includes one or more random number generators (RNGs) having a known stochastic behavior 138 for generating non-deterministic random numbers having a known probability distribution. The wagering subcontroller 136 uses outputs from the one or more random number generators 138 along with the stochastic element logic 118 to generate one or more stochastic elements as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the wagering subcontroller 136 requests a random number to be used to generate a stochastic element, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made for a random number, the random number generator generates an additional pseudorandom number and on the basis of the additional pseudorandom number, randomly selects a respective buffer to output the requested random number. In some embodiments, a respective buffer is randomly chosen by hashing a value from a real-time clock circuit to create a random index value that is then used to select from between the respective buffers.

In some embodiments, a stochastic component is generated by a continuous multivariate wagering system by executing stochastic component generation instructions included in stochastic component logic to generate a stochastic component from one or more random numbers output from one or more random number generators. In various embodiments, the stochastic component is a random number. In some embodiments, the stochastic component is a hash of a random number output by a random number generator in order to reduce the range of values of the random number so that the stochastic component can be used as an index into a lookup table or the like.

In some embodiments, an objective is generated by a continuous multivariate wagering system by executing objective generation commands included in objective logic that define processes of a multivariate wagering process where the objective generation commands are formatted in a scripting language. During a multivariate wagering process, a decision engine of a process controller generates the objective generation commands in the form of a script written in the scripting language. The script includes the objective generation commands that describe how the wagering subcontroller is to generate data of an objective. The wagering subcontroller parses the script encoded in the objective generation command data and executes the commands included in the script to generate data of the objective.

In some embodiments, an objective is generated by a continuous multivariate wagering system by executing objective generation commands included in objective logic to generate a stochastic component and use the stochastic component as in index into a lookup table having stored data of a plurality of objectives.

In some embodiments, an objective is generated by a continuous multivariate wagering system by executing objective generation instructions included in objective logic to generate a stochastic component and use the stochastic component in one or more conditional statements of the objective generation instructions to control generation of data of one or more objectives.

In some embodiments, a chance-based outcome is generated by a continuous multivariate wagering system by executing chance-based outcome generation commands included in chance-based outcome logic to generate a stochastic component and use the stochastic component as in index into a lookup table having stored data of a plurality of chance-based outcomes.

In various embodiments, a process controller uses a rule-based decision engine to automatically generate an amount of application credits to award to a player based at least in part on multivariate wagering telemetry data including award state data and player interaction data with an interactive application of the continuous multivariate wagering system. In numerous embodiments, the interactive application is a skill-based interactive application and the application credits are awarded for a player's skillful interaction with the interactive application.

In several embodiments, the process controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the continuous multivariate wagering system and onto one or more credit meters 142 associated with one or more players. The metering subcontroller 140 communicates outgoing credit data to the credit processing subcontroller 105 to transfer credits off of the one or more credit meters 142 and out of the continuous multivariate wagering system.

In various embodiments, the credit process subcontroller 105 and metering subcontroller 140 process types of value committed to the one or more wagers other than credits. In embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 having a display describing a state of wagered credit accumulation and loss for the continuous multivariate wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts won, lost or accumulated.

In some embodiments, the application resource data are communicated to the wagering user interface generator 148 and used as a partial basis for generation of the wagering telemetry data 150 communicated to the interactive controller 102.

In various embodiments, the wagering user interface generator 148 also receives multivariate wagering process state data that is used as a partial basis for generation of the wagering telemetry data 150 communicated to the interactive controller 102. In some embodiments, the multivariate wagering process state data includes stochastic element data generated by the wagering subcontroller 136 during the generation of stochastic elements. In various embodiments, the wagering user interface generator 148 generates a stochastic element generation display using the one or more states of the multivariate wagering process. The stochastic element generation display is included in the wagering telemetry data 150 that is communicated to the interactive controller 102. The stochastic element generation display is automatically displayed by the interactive controller 102 using the one or more wagering user interfaces 152. In other embodiments, the multivariate wagering process state data are communicated to the interactive controller 102 and the interactive controller 102 is instructed to automatically generate the stochastic element generation display of the one or more wagering user interfaces 152.

In some embodiments, the multivariate wagering process state data includes, but is not limited to, a final state, an intermediate state, a beginning state, and/or an award state of the multivariate wagering process. For example, in a multivariate wagering process that is based on slot machine math, the final state of the multivariate wagering process may be reel positions, in a multivariate wagering process that is based on roulette wheel math, the final state may be a pocket where a ball may have come to rest, in a multivariate wagering process that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. During a multivariate wagering process, a wagering user interface generator of a process controller generates commands in the form of a script written in the scripting language. The script includes commands that describe how the interactive controller is to display multivariate wagering process state data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. During a multivariate wagering process, a wagering user interface generator of a process controller generates a document composed in the document markup language. The document includes commands that describe how the interactive controller is to display multivariate wagering process state data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. During a multivariate wagering process, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic display and audio presentation resources that the interactive controller uses to generate a wagering user interface as described herein.

In many embodiments, a process controller communicates graphic display and audio presentation resources as part of wagering telemetry data to an interactive controller. The interactive controller uses the graphic display and audio presentation resources to generate a wagering user interface as described herein.

In various embodiments, the wagering user interface generator 148 processes various types of value committed to one or more wagers. In embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the process controller 104 utilizes the one or more wagering user interfaces 152 to display certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to display aspects of a multivariate wagering process to a player including, but not limited to, amount of credits, application credits, interactive elements, or objects in play, and amounts of credits, application credits, interactive elements, or objects available.

In a number of embodiments, the wagering subcontroller 136 can accept multivariate wagering process factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering subcontroller, so that an increase/decrease in a wagered amount can be related to the change in player profile of the player in the interactive application. In this manner, a player can control a wager amount per wagering event in accordance with the multivariate wagering process with the change mapping to a parameter or component that is applicable to the interactive application experience.

In some embodiments, the process controller 104 includes a session subcontroller 154 is used to regulate a continuous multivariate wagering system session. In various embodiments, components of the process controller 104 communicate session data to the session subcontroller 154. The session data may include, but is not limited to, player data, interactive controller data, pooled bet and side bet data, process controller data and wagering subcontroller data used by the session subcontroller to regulate a continuous multivariate wagering system session.

In some embodiments, the session subcontroller 154 may also assert control of a continuous multivariate wagering system session by communicating session control data to components of the process controller 104. Such control may include, but is not limited to, commanding the process controller 104 to end a continuous multivariate wagering system session, initiating wagering in a continuous multivariate wagering system session, ending wagering in a continuous multivariate wagering system session but not ending a player's use of the interactive application portion of the continuous multivariate wagering system, and changing from real credit wagering in a continuous multivariate wagering system to virtual credit wagering, or vice versa.

In many embodiments, the session subcontroller 154 manages player profiles for a plurality of players. The session subcontroller 154 stores and manages data about players in order to provide authentication and authorization of players of the continuous multivariate wagering system 100. In some embodiments, the session subcontroller 154 also manages geolocation information to ensure that the continuous multivariate wagering system 100 is only used by players in jurisdictions were wagering is approved. In various embodiments, the session subcontroller 154 stores application credits that are associated with the player's use of the interactive application of the continuous multivariate wagering system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154.

In some embodiments, the wagering subcontroller 136 communicates wagering session data to the session subcontroller 154. In various embodiments, the session subcontroller communicates wagering session control data to the wagering subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and the corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the continuous multivariate wagering system and to determine outgoing credit data representing amounts of credits to be transferred out of the continuous multivariate wagering system. During a multivariate wagering process, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the process controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the continuous multivariate wagering system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the continuous multivariate wagering system 100.

In some embodiments, the credit processing subcontroller 105 can use a TITO system along with a ticket or voucher printer as one of the one or more credit output devices 146 to generate a TITO ticket as a credit output for a player. During a multivariate wagering process, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, a credit processing interface 156 resident in the credit processing subcontroller 105 provides an interface between the credit processing subcontroller 156 and the process controller 104.

In some embodiments, the credit processing interface 156 implements a credit processing subcontroller to process controller communication protocol employing an interprocess communication protocol so that the process controller 104 and the credit processing subcontroller 105 may be implemented on the same device. During a multivariate wagering process, the credit processing interface 156 provides application programming interfaces that are used by the credit processing subcontroller 105 to communicate outgoing data and receive incoming data by passing parameter data to another process or application.

In some embodiments, the credit processing interface 156 implements process controller to credit processing subcontroller communication protocol employing an interdevice communication protocol so that the process controller and the credit processing subcontroller may be implemented on different devices. The interdevice protocol may utilize a wired communication bus or wireless network as a physical layer.

In various embodiments, the credit processing interface 156 implements a process controller to credit processing subcontroller communication protocol employing a networking protocol so that the process controller 104 and the credit processing subcontroller 105 may be implemented on different devices connected by a network. The networking protocol may utilize a wired communication bus or wireless network as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The wagering subcontroller 136 uses the interactive stochastic element logic 118 and outputs from the one or more random number generators 138 to generate one or more stochastic elements. Data of the one or more stochastic elements are communicated by the process controller 104, as part of the application resource data, to the interactive controller 102. The interactive application 110 uses the stochastic element data to generate an interactive user interface for the player including the one or more interactive user interfaces 112. One or more players interact with the one or more interactive user interfaces 112 through the one or more user interface input and output devices 114. The interactive application 110 detects the player interactions and determines an award state based on the detected interactions of the one or more players using the multivariate wagering process logic 116 and communicates data of the award state as part of the multivariate wagering telemetry data 150 to the process controller 104. The wagering subcontroller 136 receives the award state data and determines a wagering outcome based on the award state data, and instructs the metering subcontroller 140 to add credits to, or deduct credits from, the one or more credit meters 110 based in part on the wagering outcome data. For example, in some embodiments, the metering subcontroller is instructed to add an amount of credits to a credit meter of the one or more credit meters 110 when the wagering outcome indicates a win for a player associated with the credit meter. In various embodiments, the metering subcontroller is instructed to deduct an amount of credits from the credit meter when the wagering outcome data indicates a loss for the player. At an end of a wagering session, the metering subcontroller 140 transfers credits off of the one or more credit meters 110 and out of the continuous multivariate wagering system by communicating outgoing credit data to the credit processing subcontroller 105. The credit processing subcontroller 105 uses the outgoing credit data to generate one or more credit output items using the one or more credit output devices 146.

In another embodiment, a continuous multivariate wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many embodiments, one or more components of a continuous multivariate wagering system are distributed in close proximity to each other and communicate using a local area network and/or a communication bus. In several embodiments, an interactive controller and a process controller of a continuous multivariate wagering system are in a common location.

In various embodiments, these multiple controllers and subcontrollers can be constructed from or configured using a single device or a plurality of devices so that a continuous multivariate wagering system is executed as a system in a virtualized space such as, but not limited to, where a wagering subcontroller and a process controller are large scale centralized servers and are operatively connected to distributed interactive controllers via a wide area network such as the Internet or a local area network. In some embodiments, the components of a continuous multivariate wagering system may communicate using a networking protocol or other type of device-to-device communications protocol.

In various embodiments of a continuous multivariate wagering process, an interactive application may require extensive processing resources from an interactive controller leaving few processing resources for the functions performed by a process controller and/or a wagering subcontroller. By virtue of the architecture described herein, processing loads may be distributed across multiple devices so that operations of the interactive controller may be dedicated to the interactive application and the operations of the process controller and/or wagering subcontroller are not burdened by the requirements of the interactive application, thus improving the functioning of both the interactive controller and the process controller.

In another embodiment, a single process controller may provide services to two or more interactive controllers, thus allowing a continuous multivariate wagering system to operate more efficiently over a large range of scaling.

In another embodiment, multiple types of interactive controllers using different operating systems may be interfaced to a single type of process controller without requiring customization of the process controller, thus improving the efficiency of the process controller by reducing complexity associated with maintaining separate process controllers for each type of interactive controller.

In another embodiment, an interactive controller may be provided as a player device under control of a player while maintaining the process controller in an environment under the control of a regulated operator of wagering systems.

In another embodiment, data communicated between the controllers may be encrypted to increase security of the continuous multivariate wagering system.

In another embodiment, processing loads associated with the continuous multivariate wagering process are distributed across multiple devices so that operations of the interactive controller may be dedicated to an interactive application and the processes of the process controller are not burdened by the requirements of the interactive application.

In another embodiment, an interactive controller is an interactive application server acting as a host for managing head-to-head player interactions over a network of interactive subcontrollers connected to the interactive server using a communication link. The interactive server provides a distributed environment where players can compete directly with one another and interact with other players.

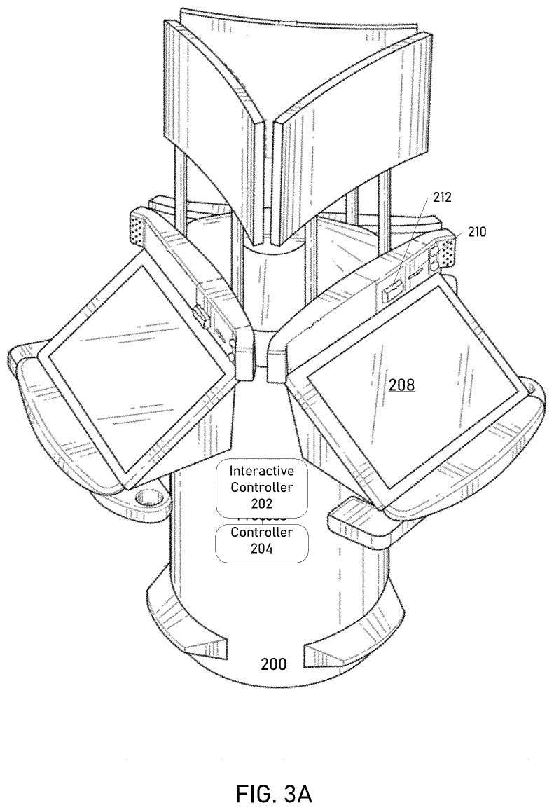

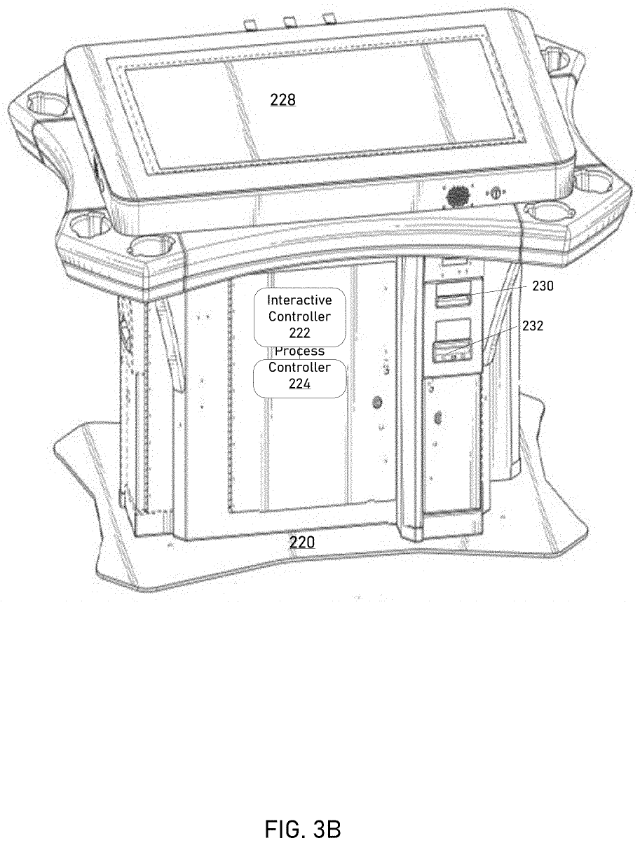

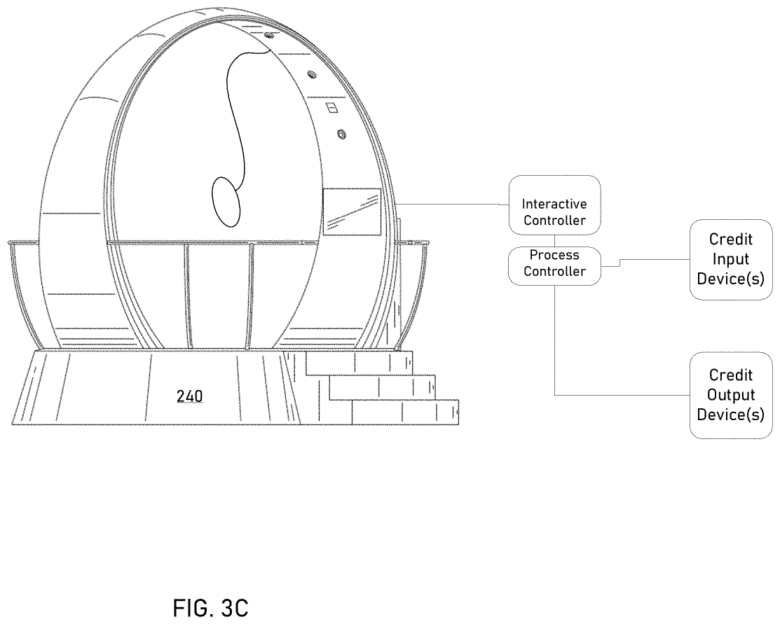

FIG. 3A is a diagram of an electronic gaming machine configuration of a continuous multivariate wagering system in accordance with various embodiments of the invention. Electronic gaming machine configurations of a continuous multivariate wagering system include, but are not limited to, electronic gaming machines such as slot machines, table games, video arcade consoles and the like. An electronic gaming machine configuration of a continuous multivariate wagering system 200 includes an interactive controller 202 as described herein and a process controller 204 as described herein contained in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The interactive controller 202 communicates with the user input devices to detect player interactions with the continuous multivariate wagering system and commands and controls the user output devices to provide a user interface to one or more players of the continuous multivariate wagering system as described herein. The process controller 204 communicates using a credit processing subcontroller to one or more player credit processing devices, such as credit input device 210 and credit output device 212 to transfer credits into and out of the continuous multivariate wagering system as described herein.

In various embodiments, the process controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the process controller 204 as described herein.

In some embodiments, the credit processing subcontroller is operatively connected to, and communicates with, a TITO system (not shown) or the like to determine incoming credit data representing amounts of credits to be transferred into the continuous multivariate wagering system 200 and to generate outgoing credit data representing amounts of credits to be transferred out of the continuous multivariate wagering system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 204 is operatively connected to a central determination controller (not shown) as described herein.

In various embodiments, the process controller 204 may be operatively connected to a progressive controller along (not shown) with one or more other process controllers of one or more other continuous multivariate wagering systems as described herein.

FIG. 3B is a diagram of multiplayer or multiplayer electronic gaming machine configuration of a continuous multivariate wagering system in accordance with various embodiments of the invention. Types of a multiplayer or multiplayer electronic gaming machine configuration a continuous multivariate wagering system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of a continuous multivariate wagering system 220 includes an interactive controller 222 as described herein and a process controller 224 as described herein contained in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein and one or more player accessible credit output devices 232 as described herein.

In some embodiments, two or more sets of credit input devices and credit output devices are provided so that each player of the multiplayer or multiplayer electronic gaming machine configuration of a continuous multivariate wagering system 220 can have an associated set of credit input devices and credit output devices.

The interactive controller 222 communicates with the user input devices to detect player interactions with the continuous multivariate wagering system and commands and controls the user output devices to provide a user interface to one or more players of the continuous multivariate wagering system as described herein. The process controller 224 communicates with the credit processing subcontroller 226 or player credit processing devices 230 and 232 to transfer credits into and out of the continuous multivariate wagering system as described herein.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the continuous multivariate wagering system 220 and to generate outgoing credit data representing amounts of credits to be transferred out of the continuous multivariate wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other continuous multivariate wagering systems as described herein.

FIG. 3C is a diagram of virtual reality gaming machine configuration of a continuous multivariate wagering system in accordance with various embodiments of the invention. Types of a virtual reality gaming machine configuration of a continuous multivariate wagering system include, but are not limited to, virtual reality gaming machines, virtual reality slot machines, virtual reality gaming devices, virtual reality arcade consoles and the like. A virtual reality gaming machine 240 configuration of a continuous multivariate wagering system includes an interactive controller, a process controller and a credit processing subcontroller contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of a continuous multivariate wagering system further includes a player area having virtual reality sensors for sensing player interactions and/or player movements within the player area, a player headset having a stereoscopic visual display for display of a stereoscopic interactive user interface to a player, headphones for presenting a stereophonic sound presentation to a player, and one or more subwoofers for providing a hepatic or low frequency auditory presentation to the player.

The interactive controller communicates with the user input devices to detect player interactions with the virtual reality continuous multivariate wagering system and commands and controls the user output devices to provide a user interface to one or more players of the virtual reality continuous multivariate wagering system as described herein. The process controller communicates with the credit processing subcontroller or player credit processing devices and to transfer credits into and out of the continuous multivariate wagering system as described herein.

In many embodiments, the process controller is further connected to one or more side betting terminals that enable spectators of a player using the virtual reality continuous multivariate wagering system to make side bets based on the performance of the player.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the continuous multivariate wagering system 220 and to generate outgoing credit data representing amounts of credits to be transferred out of the continuous multivariate wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other continuous multivariate wagering systems as described herein.

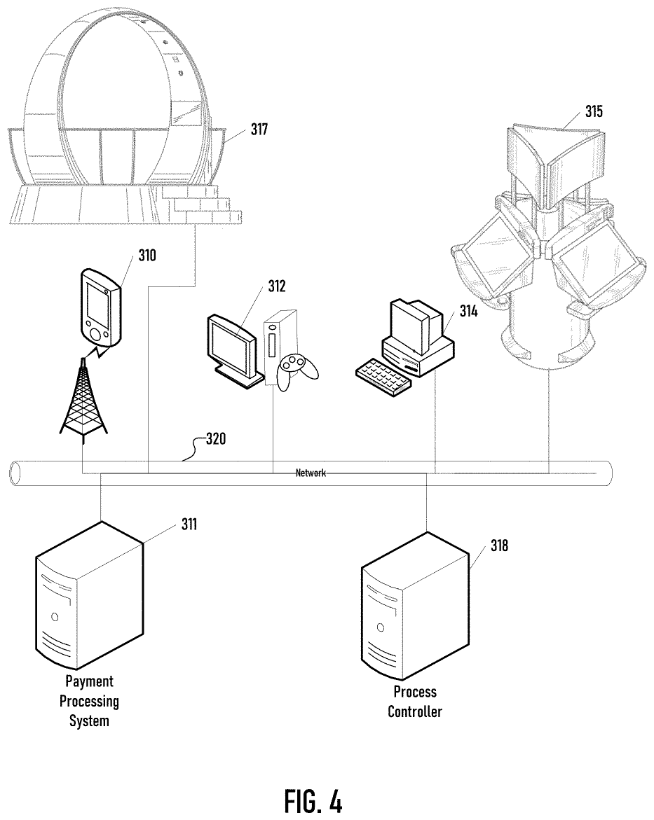

FIG. 4 is a diagram of distributed continuous multivariate wagering systems in accordance with various embodiments of the invention. An interactive controller, such as interactive controller 102 of FIG. 2, may be constructed from or configured using one or more processing devices that perform the operations of the interactive controller. An interactive controller in a distributed continuous multivariate wagering system may be constructed from or configured using any processing device having sufficient processing and communication capabilities to perform the processes of an interactive controller in accordance with various embodiments of the invention. In some embodiments, the construction or configuration of the interactive controller may be achieved through the use of an application control interface, such as application control interface 122 of FIG. 2, and/or through the use of an interactive application, such as interactive application 110 of FIG. 2.

In many embodiments, a continuous multivariate wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a continuous multivariate wagering system are distributed in close proximity to each other and communicate using a local area network and/or a communication bus. In several embodiments, an interactive controller and a process controller of a continuous multivariate wagering system are in a common location and communicate with an external wagering subcontroller. In some embodiments, a process controller and a wagering subcontroller of a continuous multivariate wagering system are in a common location and communicate with an external interactive controller. In many embodiments, an interactive controller, a process controller, and a wagering subcontroller of a continuous multivariate wagering system are located in a common location. In some embodiments, a session subcontroller is located in a common location with a process controller and/or a wagering subcontroller.

In various embodiments, these multiple devices can be constructed from or configured using a single device or a plurality of devices so that a continuous multivariate wagering system is executed as a system in a virtualized space such as, but not limited to, where a process controller is a large scale centralized server in a cloud networking environment operatively connected to widely distributed interactive controllers via a wide area network such as the Internet or a local area network. In embodiments, the components of a continuous multivariate wagering system may communicate using a networking protocol or other type of device-to-device communications protocol.

In some embodiments, a continuous multivariate wagering system is deployed over a local area network or a wide area network in a mobile configuration. A mobile configuration of a continuous multivariate wagering system is useful for deployment over wireless communication network, such as a wireless local area network or a wireless telecommunications network. A mobile configuration of a continuous multivariate wagering system includes an interactive controller operatively connected by a wireless network to a process controller and a wagering subcontroller.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, an interactive controller may be constructed from or configured using an electronic gaming machine 315, such as a slot machine or the like, or a virtual reality electronic gaming machine 317. The electronic gaming machines may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a video gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete continuous multivariate wagering system and may be operatively connected using a communication link to a session and/or management controller.

Some continuous multivariate wagering systems in accordance with many embodiments of the invention can be distributed across a plurality of devices in various configurations. One or more interactive controllers of a distributed continuous multivariate wagering system, such as but not limited to, a mobile or wireless device 310, a gaming console 312, a personal computer 314, an electronic gaming machine 315, and a virtual reality gaming machine are operatively connected with a process controller 318 of a distributed continuous multivariate wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315 and a virtual reality gaming machine while one or more processes of a process controller as described herein can be executed by the process controller 318.

In many embodiments, a distributed continuous multivariate wagering system and may be operatively connected using a communication link to a session controller (not shown), that performs the processes of a session controller as described herein.

In several embodiments, a distributed continuous multivariate wagering system and may be operatively connected using a communication link to credit processing system 311, that performs the processes of one or more credit processing systems as described herein.

In some embodiments, a distributed continuous multivariate wagering system allows for the processing of portions of a continuous multivariate wagering process on a non-secure interactive controller that is in the possession of a player while other portions of the continuous multivariate wagering process are processed on a secure process controller in the possession of an operator. This improves the functioning of both controllers as an amount of information that must be transferred across a communications network is reduced.

In some embodiments, a distributed continuous multivariate wagering system can minimize resource starving during the implementation of complex continuous multivariate wagering processes. In an example embodiment, a continuous multivariate wagering process includes randomly spawning interactive game objects in a game space displayed on an interactive user interface displayed to a player. In addition, chance-based outcomes of the continuous multivariate wagering process are generated using system stochastic events. By virtue of a distributed continuous multivariate wagering system the interactive game objects can be spawned on a non-secure interactive controller that may be in the possession of a player, while the chance-based outcomes are generated on a secure device in the possession of a regulated operator. By allocating spawning of the interactive game objects to an interactive controller coupled to a process controller by a secure communications link, data of the spawned interactive game objects need not be communicated over the network, instead, only stochastic components generated by the process controller in a secure environment are needed to be communicated.

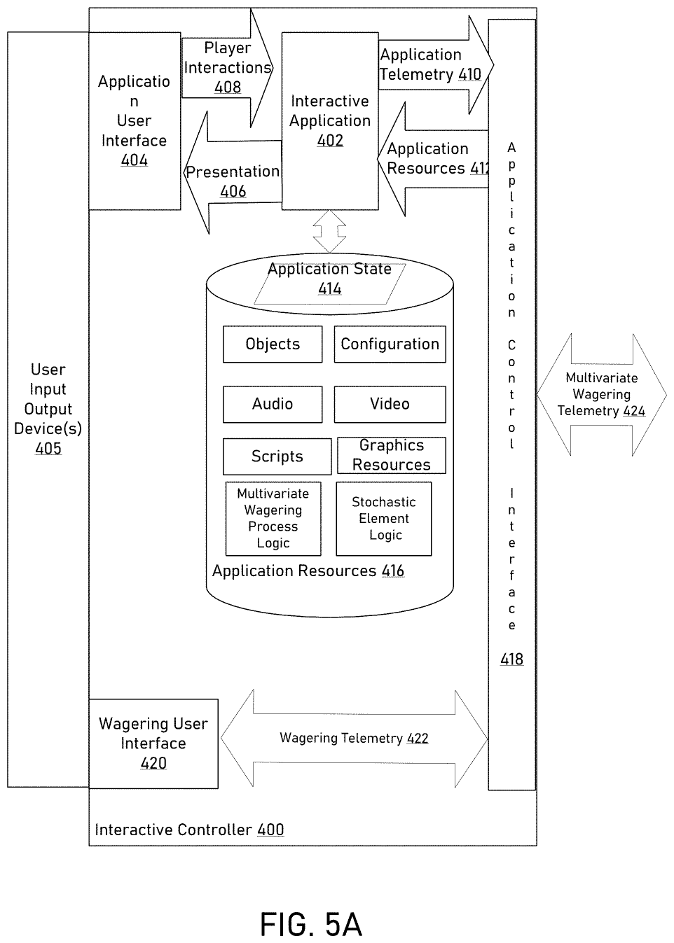

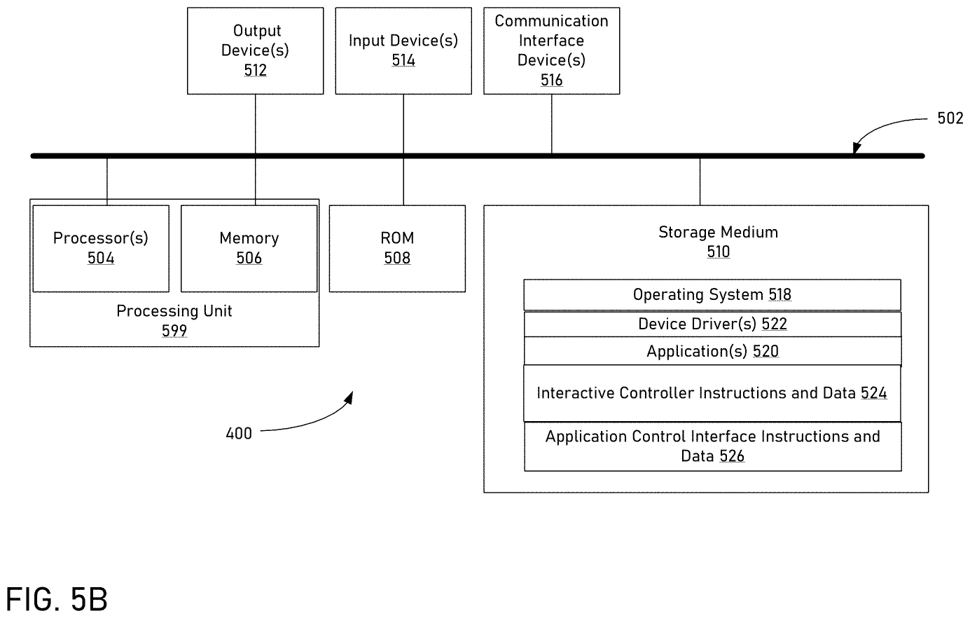

FIGS. 5A and 5B are architecture diagrams of an interactive controller in accordance with various embodiments of the invention. Referring now to FIG. 5A, an interactive controller 400, suitable for use as interactive controller 102 of FIG. 2, provides an execution environment for an interactive application 402 of a continuous multivariate wagering system. In several embodiments, an interactive controller 400 of a continuous multivariate wagering system provides an interactive application 402 that generates an application interface 404 for interaction with by one or more players. The interactive application 402 generates an interactive user interface 406 that is presented to the player through the application interface 404 using one or more user input and output devices 405. The interactive user interface 406 may include audio features, visual features or tactile features, or any combination of these features. In various embodiments, the application interface 404 utilizes one or more user interface input and output devices 405 so that a player can interact with the interactive user interface 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, ear buds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 as part of multivariate wagering telemetry data 424 to various other components of a continuous multivariate wagering system as described herein. The interactive application 402 receives application resources 412 communicated as part of multivariate wagering telemetry data 424 from various other components of a continuous multivariate wagering system as described herein. In some embodiments, the multivariate wagering telemetry data 424 may include player interactions with objects of the interactive application and an award state of a multivariate wagering process presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between interactive elements in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller 400. The application resources 416 may include objects having graphics and/or control logic used to provide interactive elements of the interactive application. In various embodiments, the resources may also include, but are not limited to, video files that are used to generate a portion of the interactive user interface 406; audio files used to generate music, sound effects, etc. within the interactive application; configuration files used to configure the features of the interactive application; scripts or other types of control code used to provide various features of the interactive application; graphics resources such as textures, objects, etc. that are used by a graphics engine to render objects displayed in an interactive application; multivariate wagering process logic used to determine one or more states of a multivariate wagering process using player interactions with the interactive user interface; and stochastic element logic used by the interactive application to generate one or more stochastic elements used as application resources.

During a multivariate wagering process, components of the interactive application 402 read portions of the application state 414 and generate the interactive user interface 406 for the player that is presented to the player using the user interface 404. The player perceives the interactive user interface and provides player interactions 408 using the user input devices and user output devices 405. The corresponding player interactions are detected as player actions or inputs by various components of the interactive application 402. The interactive application 402 translates the player actions into interactions with the interactive elements of the interactive application. Components of the interactive application use the player interactions with the interactive elements of the interactive application and the interactive application state 414 to update the application state 414 and update the interactive user interface 406 presented to the player. The process loops continuously while the player interacts with the user interfaces of the interactive application of the continuous multivariate wagering system.

The interactive controller 400 provides one or more interfaces 418 between the interactive controller 400 and other components of a continuous multivariate wagering system, such as, but not limited to, a process controller. The interactive controller 400 and the other continuous multivariate wagering system components communicate with each other using the interface. The interface may be used to pass various types of data, and to communicate and receive messages, status data, commands and the like. In certain embodiments, the interactive controller 400 and a process controller communicate wagering telemetry data 424. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as detected by the interactive application. The player interactions may also include resultant actions such as modifications to the application state 414 or game resources 416 resulting from the player's interactions taken in the continuous multivariate wagering system interactive application. In some embodiments, player interactions include, but are not limited to, actions taken by entities such as non-player characters (NPCs) of the interactive application that act on behalf of or under the control of the player.

In various embodiments, the application resources 412 include application resources used by the interactive application 402 to generate an interactive user interface of a multivariate wagering process presented to a player and to determine intermediate states based on the player's skillful interaction with the interactive user interface. In many embodiments, data of the application resources 412 includes data of one or more stochastic elements as described herein.

In some embodiments, the interactive controller 400 includes a wagering user interface 420 used to provide and receive wagering telemetry data 422 to and from the player. The continuous multivariate wagering system telemetry data 422 from the continuous multivariate wagering system includes, but is not limited to, data used by the player to configure a wager, data used to communicate, as part of multivariate wagering telemetry data 424, a state of a continuous multivariate wagering process, and data about a continuous multivariate wager outcome.

In some embodiments, an interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller communicates sensor telemetry data to one or more components of the continuous multivariate wagering system.

Referring now to FIG. 5B, interactive controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

The one or more communication interface devices 516 provide one or more wired or wireless interfaces for communicating data and commands between the interactive controller 400 and other devices that may be included in a continuous multivariate wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and continuous multivariate wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

During a multivariate wagering process, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a continuous multivariate wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many embodiments, an interactive controller of a continuous multivariate wagering system includes an interactive application server operatively connected to an interactive client using a communication link. The interactive application server and interactive application client cooperate to provide the features of an interactive controller as described herein.

In various embodiments, the interactive controller 400 may be used to construct other components of a continuous multivariate wagering system as described herein.

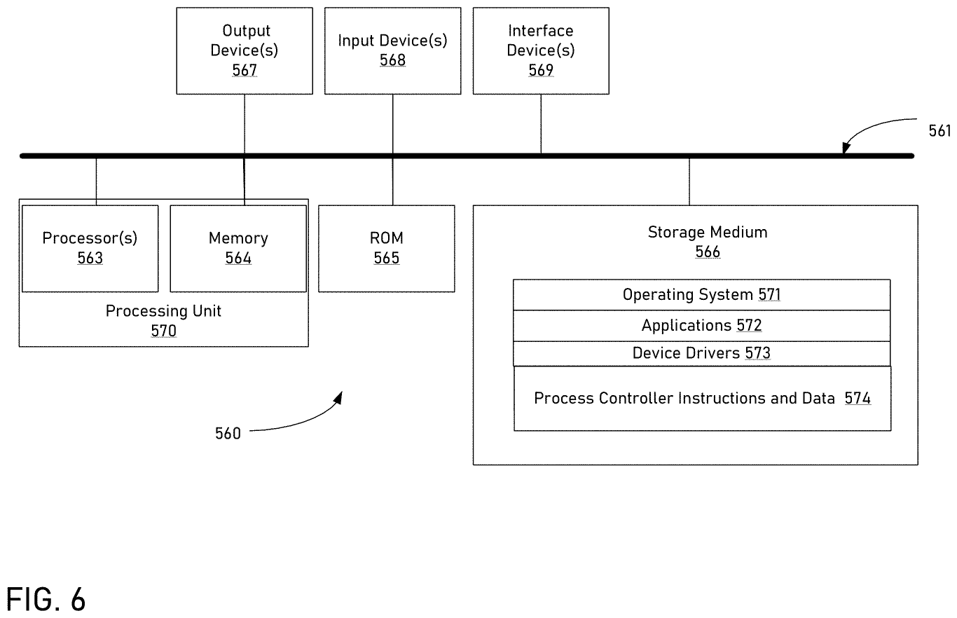

FIG. 6 is an architecture diagram of a process controller, suitable for use as process controller 104 of FIG. 2, of a continuous multivariate wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a process controller processing unit 570. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

The one or more communication interface and/or network interface devices 569 provide one or more wired or wireless interfaces for exchanging data and commands between the process controller 560 and other devices that may be included in a continuous multivariate wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the process controller 560 such as, but not limited to: an operating system 571; one or more applications 572; one or more device drivers 573; and continuous multivariate wagering system process controller instructions and data 574 for use by the one or more processors 563 to provide the features of a process controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

During a multivariate wagering process, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the process controller 560 to provide the features of a continuous multivariate wagering system process controller as described herein.

Although the process controller 560 is described herein as being constructed from or configured using one or more processors and instructions stored and executed by hardware components, the process controller can be composed of only hardware components in accordance with other embodiments. In addition, although the storage medium 566 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the process controller 560 may be used to construct other components of a continuous multivariate wagering system as described herein.

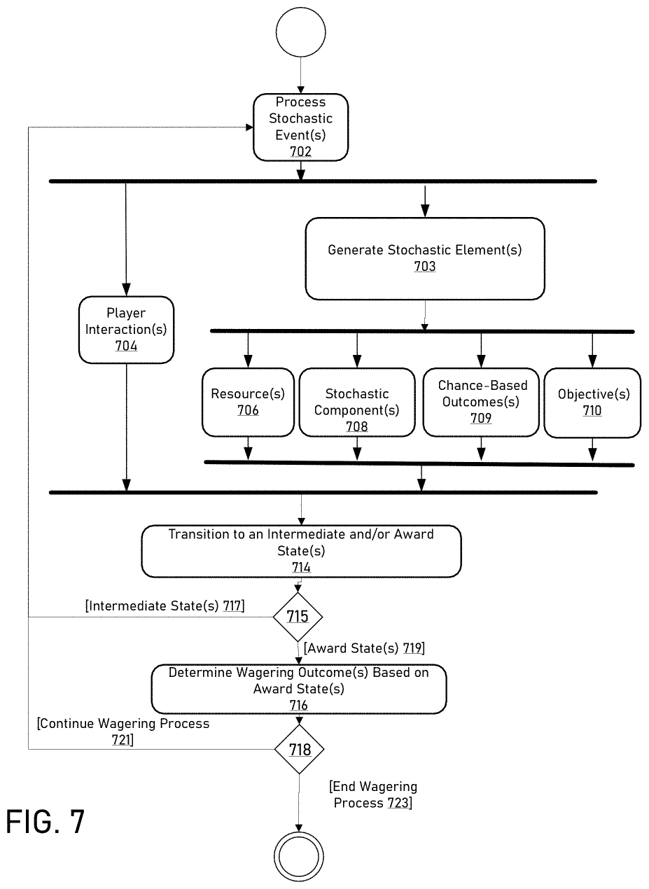

FIG. 7 is an activity diagram illustrating a process of a continuous multivariate wagering process of a continuous multivariate wagering system in accordance with various embodiments of the invention. In many embodiments, a continuous multivariate wagering system determines 716 a wagering outcome for a multivariate wagering process by executing one or more iterations of a continuous multivariate wagering process where the continuous multivariate wagering system detects stochastic events in the form of player interactions and generates stochastic events in the form of stochastic elements as described herein. In an example embodiment, a multivariate wagering process for a number of states of the multivariate wagering process 700, while in a state that is expecting a stochastic transition, the continuous multivariate wagering system processes 702 one or more stochastic events, including but not limited to, one or more interactive stochastic events such as player interactions 704 that cause a transition to a next state, or may detect one or more system stochastic events such as by generating 703 one or more stochastic elements such as one or more interactive application resources 706, one or more stochastic components 708, one or more chance-based outcomes 709, and/or one or more objectives 710, thus causing a transition to a next state. The continuous multivariate wagering system transitions 714 to one or more intermediated and/or award states based one the stochastic events that the continuous multivariate wagering system either detects or generates.

If the continuous multivariate wagering system determines 715 that it is in an intermediate state, the continuous multivariate wagering system continues 717 to process 702 stochastic events. If the continuous multivariate wagering system determines 715 that it is in an award state 719, the continuous multivariate wagering system, uses one or more award states to determine 716 a wagering outcome for the multivariate wagering process.

If the continuous multivariate wagering system determines 718 that it is to continue the multivariate wagering process, the continuous multivariate wagering system continues 721 to process 702 stochastic events. If the continuous multivariate wagering system determines 718 that it is to end the multivariate wagering process, the continuous multivariate wagering system ends 723 the multivariate wagering process.

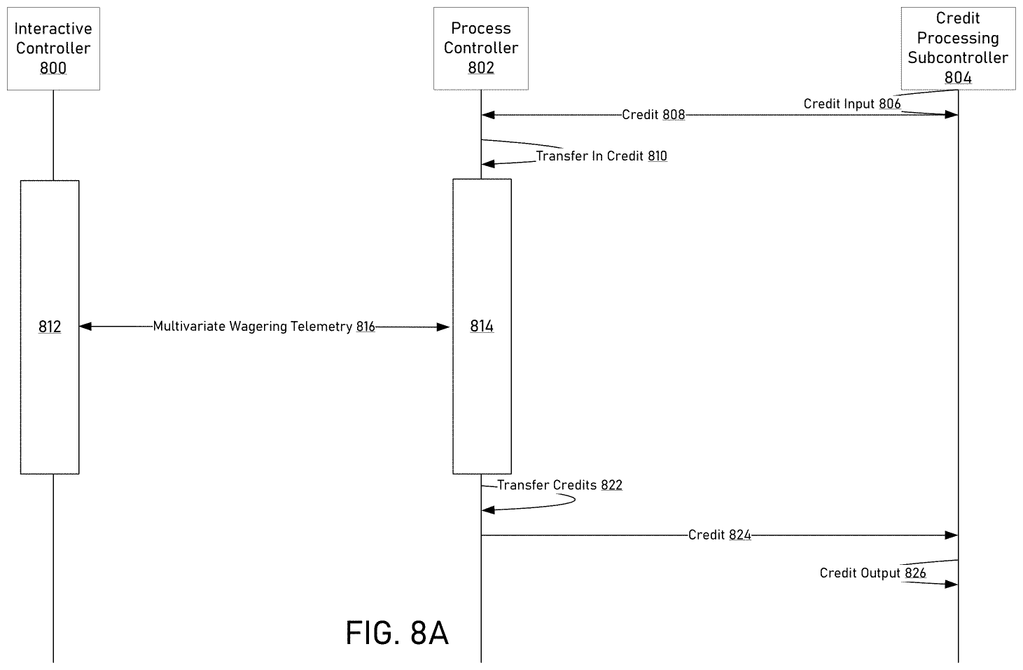

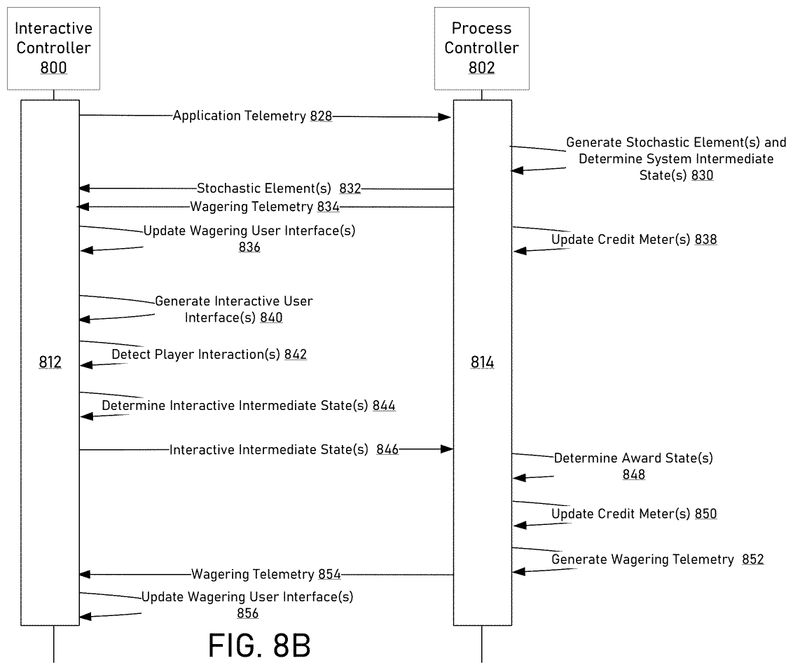

FIGS. 8A and 8B are sequence diagrams illustrating a process of a continuous multivariate wagering process of a continuous multivariate wagering system in accordance with various embodiments of the invention. A continuous multivariate wagering system allows for the management of a multivariate wagering process for one or more players. In some embodiments of a continuous multivariate wagering system, an interactive application executed by an interactive controller provides the multivariate wagering process to the one or more players of the continuous multivariate wagering system. The interactive controller is operatively connected to a process controller that manages crediting and other administrative processes as well as generating one or more stochastic elements and determining one or more system intermediated states. The stochastic elements are communicated to the interactive application for use in the multivariate wagering process. The interactive controller determines one or more interactive intermediate states based on logic of the multivariate wagering process, the one or more stochastic elements, and detection of one or more stochastic player interaction events. The intermediate states are communicated by the interactive controller to the process controller and the process controller uses the interactive intermediated states and the system intermediate states to determine one or more award states representing a wager outcome for the multivariate wagering process.

Referring now to FIG. 8A, in some embodiments, at a beginning of the wagering session, the process includes a credit input 806 to the continuous multivariate wagering system with a process controller 802 communicating with a credit processing subcontroller 804 to receive incoming credit data 808. The process controller 802 uses the incoming credit data to transfer 810 credits onto one or more player credit meters associated with one or more players of the continuous multivariate wagering system, thus transferring credits into the continuous multivariate wagering system and on to the one or more player credit meters.

During the multivariate wagering process 812 and 814, an interactive controller 800 and the process controller 802 communicate multivariate wagering telemetry data 816 used by the controllers to implement the multivariate wagering process. The data communicated includes data of, but is not limited to, application telemetry, application resources, wagering telemetry, intermediate states, and/or award states of the multivariate wagering process as described herein.

In many embodiments, upon determining that a wagering session is completed, such as by receiving a cashout communication from the one or more players of the continuous multivariate wagering system, the process controller 802 transfers 822 credits off of the one or more player credit meters, generates outgoing credit data 824 on the basis of the credits transferred off of the one or more player credit meters, and communicates the outgoing credit data 824 to the credit processing subcontroller 804. The credit processing subcontroller 804 receives the outgoing credit data 824 and generates 826 a credit output as described herein, thus transferring credits off of the one or more player credit meters and out of the continuous multivariate wagering system.

Referring now to FIG. 8B, in slightly more detail, the interactive controller 800 communicates interactive multivariate wagering telemetry data 828 to the process controller 802. The interactive multivariate wagering telemetry data 828 includes, but is not limited to, data of one or more player interactions detected by the interactive controller 800 and/or one or more interactive application events.

The process controller 802 receives the interactive multivariate wagering telemetry data 828. Upon determination by the process controller 802 that the interactive application telemetry indicates a stochastic element of the multivariate wagering process is to be generated in accordance with a state of the multivariate wagering process, the process controller 802 generates 830 one or more stochastic elements. In the case that one or more of the stochastic elements is generated in association with a commitment of an amount of credits to a wager, the process controller 802 updates 838 one or more credit meters to reflect the wager commitment. The process controller 802 communicates data of the stochastic elements 832 to the interactive controller 800 along with wagering telemetry data 834 concerning the wager commitment data.

The interactive controller 800 receives the stochastic element data 832 and the wagering telemetry data 834 from the process controller 802 and uses the wagering telemetry data to update 836 a wagering user interface of the interactive application. The interactive controller uses the stochastic element data 832 to generate 840 an interactive user interface for presentation to the player. The interactive user interface is presented to the one or more players in a user interface of the interactive application of the interactive controller 800. The interactive controller 800 detects 842 one or more player interactions of the one or more players with interactive elements of the interactive user interface and determines 844 one or more interactive intermediate states for the multivariate wagering process based on the detected player interactions. The interactive controller 800 communicates data of the one or more interactive intermediate states 844 to the process controller 802. The process controller 802 receives the interactive intermediate state data 844 and determines 848 one or more award states using the interactive intermediate states and the system intermediate states. The process controller updates 850 the one or more player credit meters associated with the one or more players based on the one or more award states for the multivariate wagering process, such as by incrementing an amount of credit to, or decrementing an amount of credit from, the one or more player credit meters. The process controller 802 generates 852 wagering telemetry data 854 using the one or more award states and data of the updated one or more credit meters. The process controller 802 communicates the wagering telemetry data 854 to the interactive controller 800. The interactive controller 800 receives the wagering telemetry data 854 and the interactive controller 800 updates 856 a wagering user interface on a partial basis of the wagering telemetry data 856.

In various embodiments, a process controller provides one or more stochastic components to an interactive controller. The interactive controller receives the stochastic components and uses the stochastic components to generate one or more stochastic elements of a multivariate wagering process as described herein.

In many embodiments, one or more stochastic components are used to generate one or more chance-based outcomes that are used to determine a wagering outcome.

In some embodiments, at a beginning of the wagering session, the process includes an application credit input to the continuous multivariate wagering system with the process controller 802 communicating with the credit processing subcontroller 803 to receive incoming application credit data. The process controller 802 uses the incoming application credit data to transfer application credits onto one or more application credit meters associated with one or more players of the continuous multivariate wagering system, thus transferring application credits into the continuous multivariate wagering system and on to the one or more application credit meters. The process controller 802 uses interactive intermediate state data of an interactive application to generate an amount of application credit to award to a player based on the player's achievement of one or more objectives of the interactive application. Upon determining that the wagering session is completed, such as by receiving a cashout communication from one or more players of the continuous multivariate wagering system, the process controller 802 transfers application credits off of the one or more application credit meters, generates outgoing application credit data on the basis of the application credits transferred off of the one or more application credit meters, and communicates the outgoing application credit data to the credit processing subcontroller 803. The credit processing subcontroller receives the outgoing application credit data and generates an application credit output as described herein, thus transferring application credits off of the one or more application credit meters and out of the continuous multivariate wagering system.

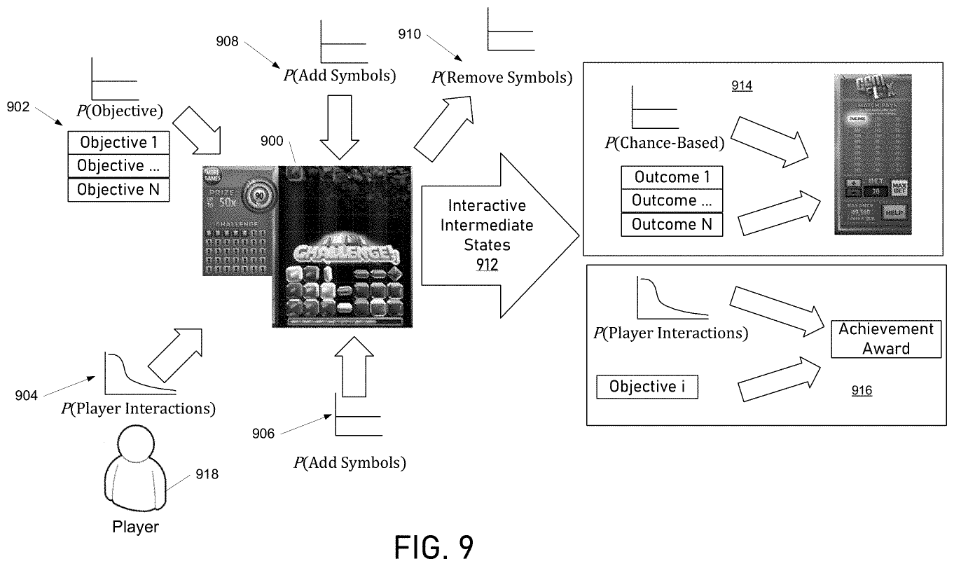

FIG. 9 is a block diagram illustrating a process of a continuous multivariate wagering system in accordance with various embodiments of the invention. In the process, a player 918 interacts with an interactive user interface 900 of an interactive application in the form of a matching game.

In an embodiment, the interactive user interface 900 of the matching game consists of a grid of symbols that the player can interact with 904 by moving the symbols within the grid to create sets of contiguous symbols. In an embodiment, a set of contiguous symbols includes three or more contiguous symbols in a linear sequence. A linear sequence can be either vertically oriented in a column of the grid, horizontally oriented in a row of the grid, or diagonally oriented spanning three or more columns and rows.

Once a set of contiguous symbols is created by the player, the system transitions to one or more interactive intermediate states 912 wherein symbols in the set are removed from the grid and a wager is executed and one or more chance-based outcomes are generated 914 and credited to the player. In an embodiment, once a linear sequence is created by the player, the symbols in the sequence are removed from the grid and a wager is executed and one or more system intermediate states in a form of chance-based outcomes are determined and credited to the player.

The continuous multivariate wagering system may randomly determine one or more system intermediate states in a form of adding symbols to the grid, 906 and 908, as stochastic components. The continuous multivariate wagering system may determine one or more system intermediate states in a form of removing 910 symbols from the grid either randomly or according to a deterministic algorithm.

In some embodiments, the continuous multivariate wagering system may randomly generate one or more system intermediate states in a form of objectives 902 for the player to achieve. The system monitors the interactive intermediate states 912 to determine if the player achieve the objective. In an example embodiment, the one or more system intermediate states indicate a player's progress in attempting to achieve the objective. Once the system determines that the player has achieved the objective, the system awards 916 an objective achievement award to the player based on the player's achievement of the objectives.

In an embodiment, the symbols have various attributes that determine how the symbols can be formed into linear sequences. In an example embodiment, the symbols have four shapes, namely a square, a four-pointed star, a horizontally oriented rectangle, and a vertically oriented rectangle. The square symbol may be used to form linear sequences horizontally, vertically, and diagonally. The four-pointed star may be used to form linear sequences horizontally and vertically. The horizontally oriented rectangle may be used to form sequences horizontally, and the vertically oriented rectangle may be used to form linear sequences vertically. In an example embodiment, the symbols have various colors and only symbols of the same color may be used to create linear sequences.

In an embodiment, a continuous multivariate wagering system may randomly generate objectives for the player to achieve and award an objective achievement award to the player based on the player's achievement of the objectives. In an example embodiment, the objective is a timed objective where the player must make linear sequences of specified types of symbols.

In an embodiment, symbols that may be moved by the player is indicated to the player by moving the symbol within the symbol's respective grid space. Whether are not a symbol may be moved is dependent upon how many other symbols are adjacent to the symbol. If a symbol has another symbol on all sides, then the symbol cannot be moved. However, if the symbol has at least one free side, the symbol can be moved to be on top of a stack of symbols within a column of the grid.

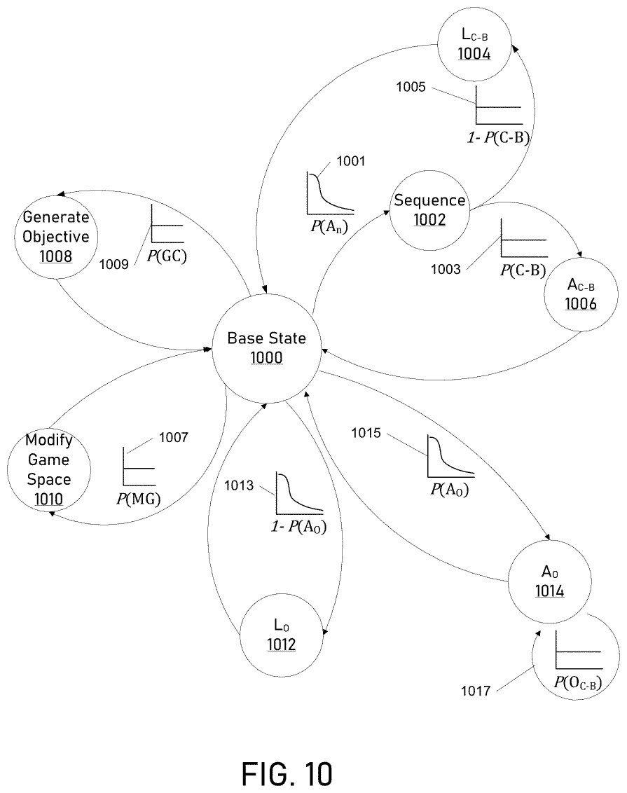

FIG. 10 is a state diagram illustrating a process of a continuous multivariate wagering process performed by a continuous multivariate wagering system in accordance with various embodiments of the invention. In the process, a player interacts with an interactive application in the form of a matching game in a base state 1000. A game space of the interactive application includes an interactive user interface of the matching game that includes a grid of symbols that the player can move within the grid to create sets of three or more contiguous symbols in a linear sequence. If the player is able to create a sequence by moving the symbols, as indicated by a player stochastic transition having a probability of P(An) 1001, the system transitions to an interactive intermediate state in a form of a sequence detected state 1002 and the system executes a wager by determining a chance-based outcome. If the wager is a winning wager, the system transitions to an award state AC-B 1006 with a probability of P(C-B) 1003, and awards an amount of credits to the player and then transitions back to the base state 1000. If the wager is a losing wager, the system transitions to a losing state LC-B 1004 with a probability of 1-P(C-B) 1005 and then transitions to the base state 1000. From the base state, the system may modify the game space of the interactive application thus transitioning to an interactive intermediate state in a form of a modify game space state 1010 with a probability of P(MG) 1007.

The system may generate an objective for the player to achieve thus transitioning to a system intermediate state by generating objective state 1008 with a probability of P(GC) 1009. If the system detects that the player has achieved the objective, the system transitions to a system intermediate state in a form of an objective achievement state AO 1014 with a probability of P(AO) 1015 and the system awards to the player an amount of credits for achieving the objective.

In some embodiments, the amount of credits awarded to the player for achieving an objective is determined by a chance-based outcome in accordance with probability transition P(OC-B) 1017.

If the system detects that the player has failed to achieve the objective, the system transitions to an objective loss state LO 1012 with a probability of 1-P(AO) 1013.

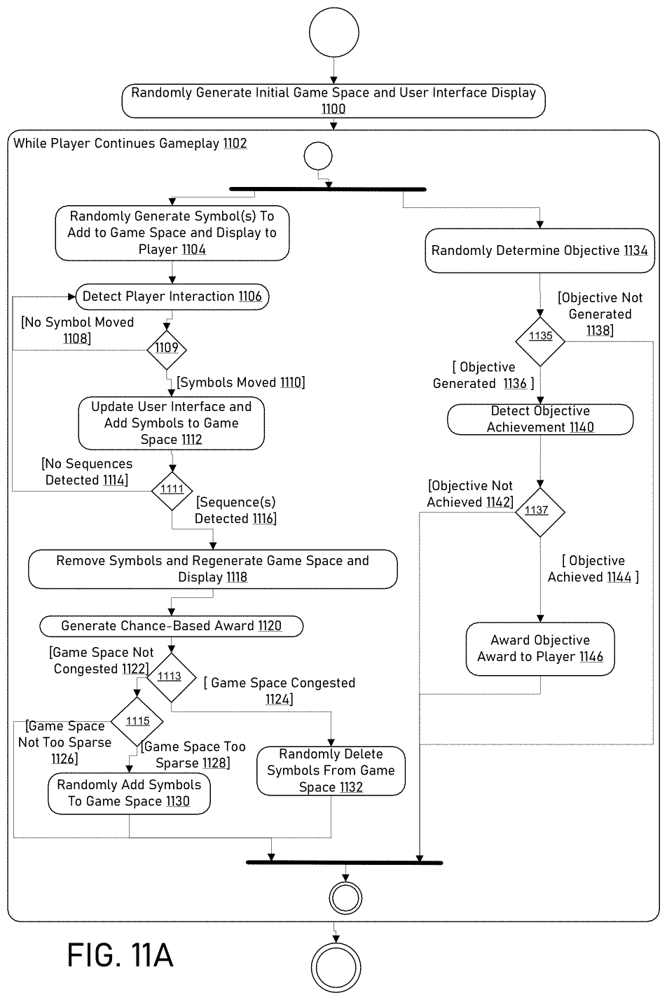

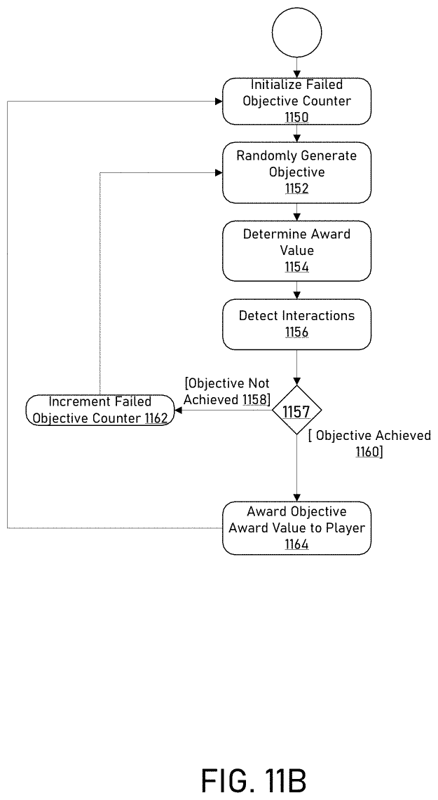

FIGS. 11A and 11B are activity diagrams illustrating a process of a continuous multivariate wagering process performed by a continuous multivariate wagering system in accordance with various embodiments of the invention. Referring now to FIG. 11A, in operation, the system randomly generates an initial game space and updates a user interface display to display the initial game space 1100. While the player continues gameplay 1102, the system randomly generates one or more symbols to add to the game space and display to the player using the user interface 1104. The system detects player interactions 1106 with the symbols displayed on the user interface. If the system determines that no symbol is moved 1108, the system continues to detect player interactions 1106.

If the system detects that a symbol has been moved 1110, the system updates the user interface and adds symbols to the game space 1112. The system then determines 1111 if any linear sequences of symbols have been created by the movement of the symbol by the player and the addition of the one or more symbols. If the system does not detect any sequences 1114, the system continues to detect player interactions 1106.

If the system detects that a sequence has been created 1116 by the moved symbol and/or the addition of the one of more new symbols, the system removes the symbols in the sequence, regenerates the game space, and displays the new game space to the player using the user interface 1118. In response to the system detecting that a sequence was formed, the system generates a chance-based award of credits to award to the player 1120. The system then determines if the game space is congested 1113, that is, that there are too many symbols within one or more of the columns of a game grid of the user interface into the game space. If the game space is congested 1124, the system randomly deletes symbols from the congested portions of the game space 1132 and updates the user interface in accordance with the newly generated game space. In some embodiments, the symbols are deleted in accordance with an algorithm. In an example embodiment, the system deletes the entire bottom row of a game grid of the user interface representing the game space. In another example embodiment, the system deletes symbols having a specified characteristic, such as color or shape.

If the system determines that game space is not congested, the system determines if the game space is too sparse 1115, that is, there are not enough symbols in the game space. If the game space is too sparse 1128, the system randomly adds one or more symbols to the game space 1130 and updates the user interface to depict the changed game space.

If the system determines that the game space is not too sparse 1126, the gameplay continues.

Simultaneously with detecting the player's creation of symbol sequences and executing chance-based wagers when sequences are created, the system randomly determines 1134 whether or not 1135 to generate an objective to present to the player. If no objective is generated 1138, gameplay simply continues.

If the system generates an objective 1136, the system detects 1140 whether or not the player has achieved the objective 1137. If the objective is achieved 1144, the system awards an objective award 1146 to the player of an amount of credits for achieving the objective. If the objective is not achieved 1142, gameplay simply continues.

In an embodiment, a difficulty of an objective is randomly determined by the system. In some such embodiments, the objective is time-based and the player is given a randomly generated amount of time in which to complete an objective of forming specified sequences and/or sets of symbols. In another embodiment, the objective is time-based and includes a specified number and types of symbols that the player needs to include in one or more sequences. In some such embodiments, a difficulty of the objective is determined by an amount of time provided to the player to complete the objective. In some such embodiments, the difficulty of the objective is determined by adjusting a number of symbols to be included in one or more sequence.

Turning now to FIG. 11B, the system in some embodiments of a multivariate wagering system keeps track of a number of times a player fails to complete an objective and increments an amount of credits to be awarded to a player for completing an objective based on the count of the failed objectives. In operation, the system initializes a failed objective counter 1150 during gameplay. The system randomly generates an objective 1152 as described herein. The system determines an award value 1154 based on the count of the failed objective counter. The system detects player interactions 1156 as described herein to determine 1157 if an objective has been achieved. If an objective has been presented to the player and the system detects that the player failed to achieve the objective 1158, the system increments the failed objective counter 1162. If the system detects that the player has achieved a presented objective 1160, the system awards the determined amount of credits to the player 1164 based on the failed objective counters.

In an embodiment, the system determines to increase the amount of awarded credits each time in direct proportion to the number of failed objectives. In another embodiment, the system adds the amount of credits determined to be awarded to the player for a failed objective to a current objective, thus rolling over the previous and failed objective's award amount into the current objective.

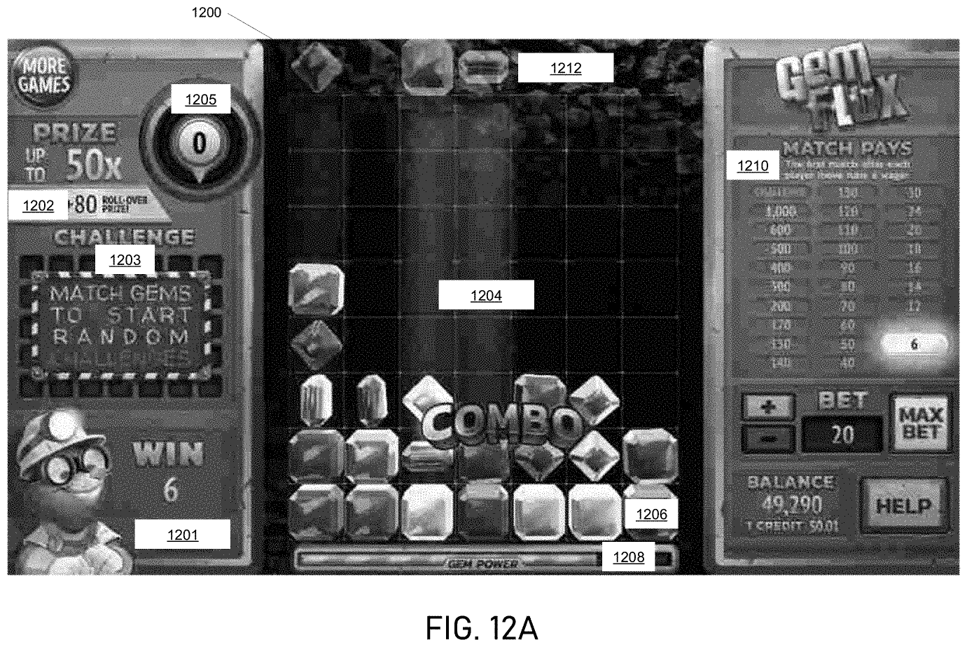

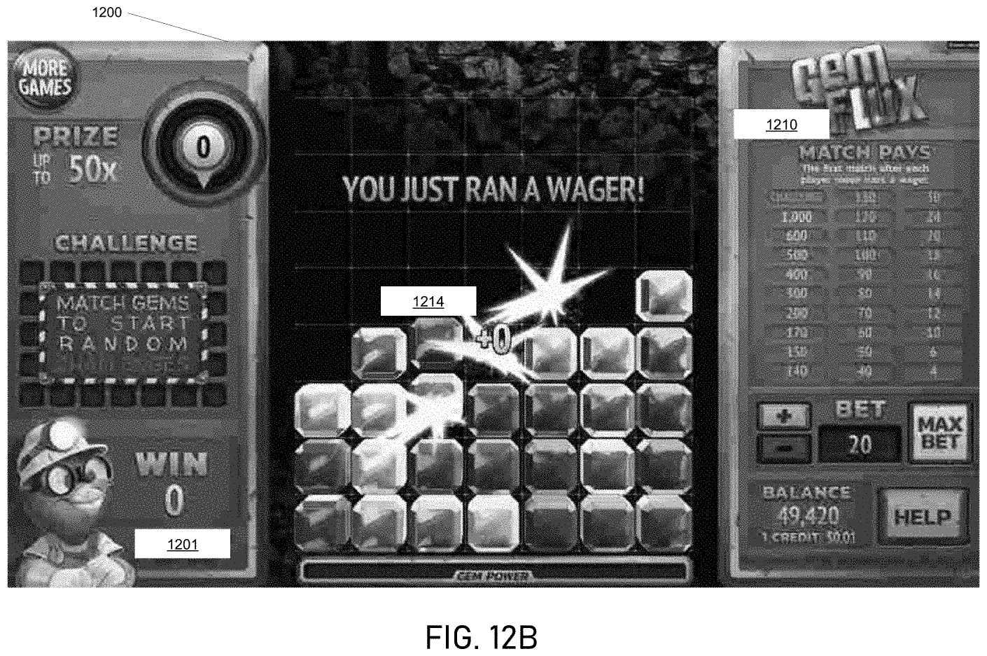

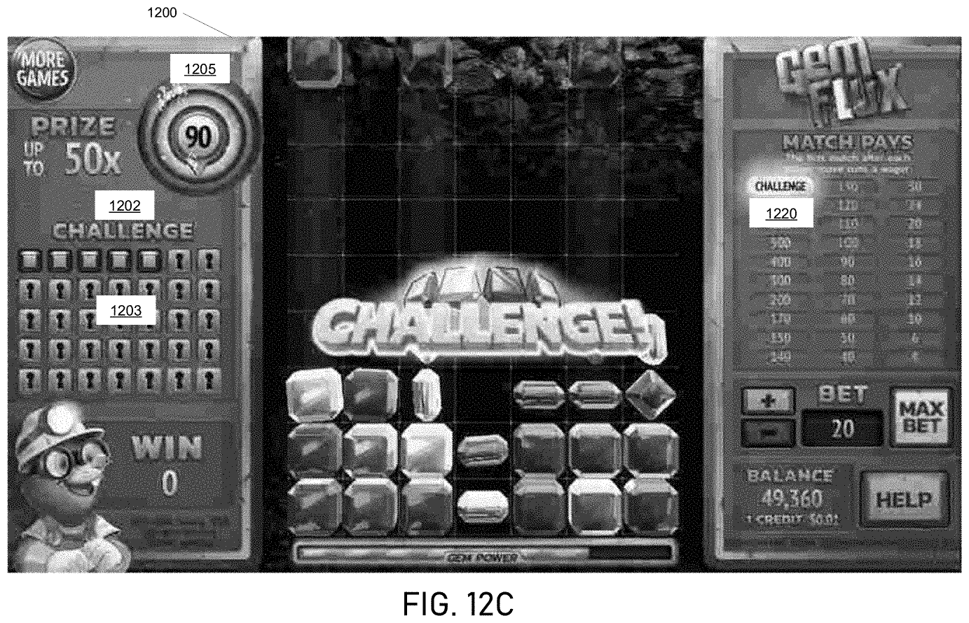

FIGS. 12A to 12C illustrate a user interface of a continuous multivariate wagering system in accordance with various embodiments of the invention. As illustrated in FIG. 12A, a user interface 1200 includes a display of a game space including a grid having rows and column 1204. Various symbols, such as symbol 1206, are randomly distributed in the grid. New symbols are introduced at a top portion of the grid 1212 by the system whenever a player moves a symbol. When the grid of the game space becomes too congested, symbols are removed from a bottom portion of the user interface. When the grid of the game space becomes too sparse, new symbols are randomly added into the bottom portion of the grid.

The user interface further includes an objective or challenge display portion 1202 for displaying an objective to the player. In some embodiments, the objective takes the form of a time-based challenge to the player to make one or more sequences of symbols using a specified number and types of symbols. The object display portion includes a grid 1203 for displaying the specified symbols of the objective and a timer 1205 for communicating time remaining in the time-based objective. The user interface further includes a plurality of wagering outcome portions, 1201 and 1210, for communicating to a player an amount of credits won when the player makes a sequence of symbols.

In an embodiment, the display of the wagering outcome further includes a randomized display sequence of possible wager outcomes. In one such embodiment, a display of all possible chance-based award credit values are displayed and the possible chance-based award credit values are randomly highlighted until a final chance-based award of an amount of credits is highlighted manner until a next wager is placed.

Turning now to FIG. 12B, when the system detects that the player has created a sequence of symbols 1214, the system executes a wager and displays to the player an amount of credits won in the wagering outcome portions, 1201 and 1210, of the user interface 1200.

Turning now to FIG. 12C, the system randomly determines one or more objectives and displays the objectives to the player in an objective display portion of the user interface 1200. In an example embodiment, the objective display portion 1202 of the user interface includes a time remaining timer 1205 for displaying to a player an amount of time remaining to the player to complete the objective and an objective symbol display portion 1203 for displaying to the player specified symbols that the player is to include in one or more sequences in order to achieve the objective.

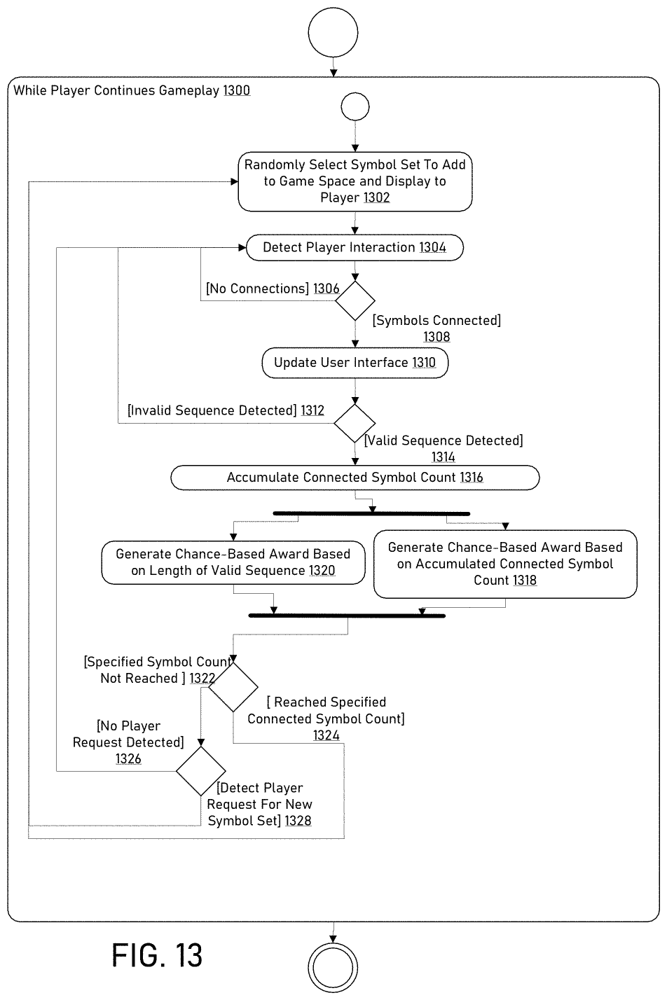

FIG. 13 is an activity diagram illustrating a process of a continuous multivariate wagering process performed by a continuous multivariate wagering system in accordance with various embodiments of the invention. In operation, while the player continues gameplay 1300, the system generates one or more stochastic elements and uses those stochastic elements to randomly select 1302 a set of symbols to be used as resources in an interactive application and updates a user interface display of the interactive application to display the set of symbols. The system detects 1304 the player's interaction in connecting symbols of the set of symbols to attempt to create valid sequences of symbols. If no connections are detected 1308, the system continues to detect 1304 player interactions. If symbol connections are detected 1308 the system updates 1310 the user interface and determines if the connected sequence of symbols is a valid sequence of symbols. If the system detects 1312 an invalid or incomplete sequence of symbols, the system continues to detect 1304 player interactions. If the system detects 1314 a valid sequence of symbols, the system accumulates 1316 a connected symbol count based on the number of symbols that were connected in the sequence. The system generates additional stochastic elements to execute a wager and generate 1320 a chance-based award based on the length of the valid sequence and a commitment of credits to the wager. In addition, the system generates additional stochastic elements to execute a wager and generate 1318 a chance-based award based on the accumulated connected symbol count and a commitment of credits to the wager. If the system detects 1324 that the accumulated connected symbol count has reached a specified symbol count associated with the randomly selected symbol set, the system generates one or more additional stochastic elements and uses them to randomly select 1302 a new symbol set for display to the player and gameplay continues. If the system does not detect 1322 that the specified symbol count has been reached, the system detects if the player is requesting a new symbol set. If so 1328, the system generates one or more additional stochastic elements and uses them to randomly select 1302 a new set of symbols for display to the player and gameplay continues. If the system does not detect 1326 that the player is requesting a new symbol set, the system continues to detect player interactions.

In an embodiment, the set of symbols is set of letters that are displayed in a circle to the player in the user interface such that the player can make connections between the symbols using a touchscreen.

In an embodiment, a paytable used to determine a chance-based award based on the length of the valid sequence is selected such that the longer the valid sequence the higher possible payouts are made available to the player.

In an embodiment, a paytable used to determine a chance-based award based on the length of the valid sequence is selected such that the longer the valid sequence the higher the return to the player of the paytable.

In an embodiment, a chance-based award based on the accumulated connected symbol count is a progressive award having an award pool that is paid into across one or more gameplay sessions of one or more players using a portion of credits wagered. A paytable used to determine the chance-based award based on the accumulated connected symbol count is selected such that the higher the accumulated connected symbol count the higher the chance that the player will be awarded the award pool. In some such embodiments, the award pool is reset to a non-zero value when the award pool is awarded to a player.

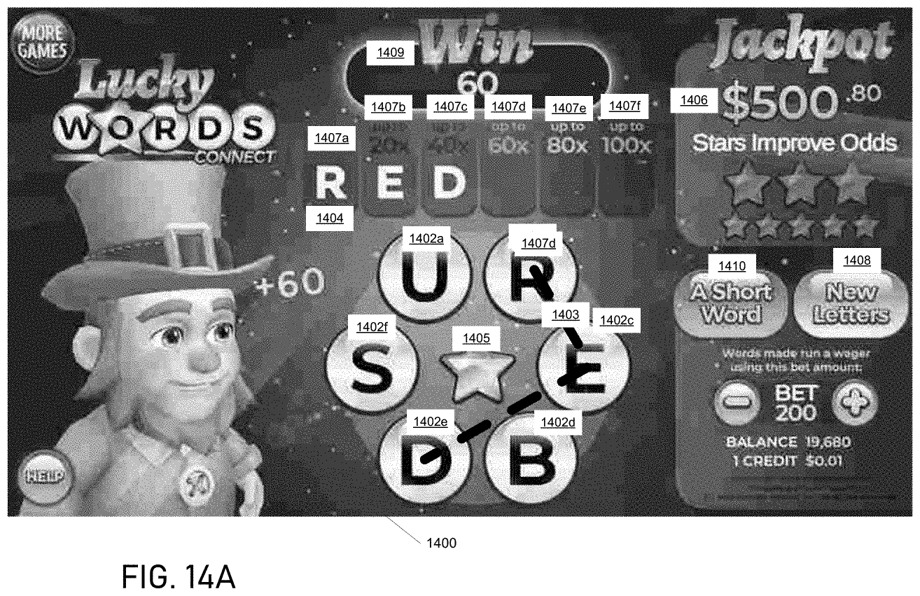

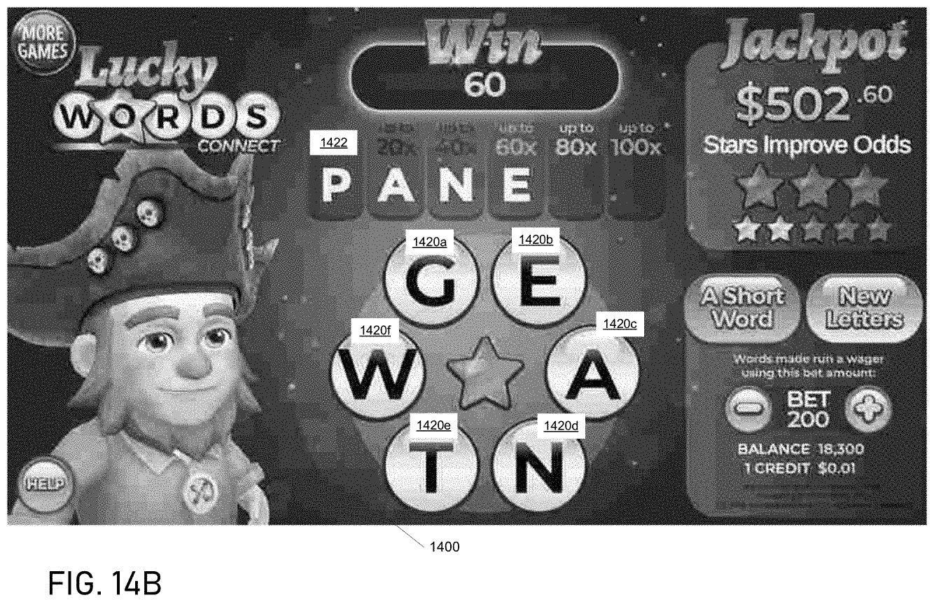

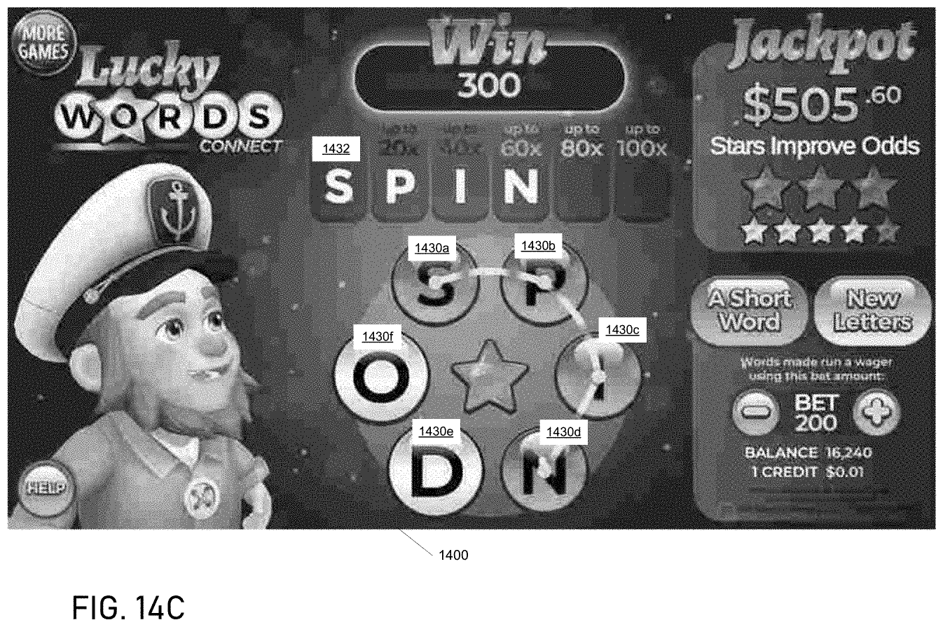

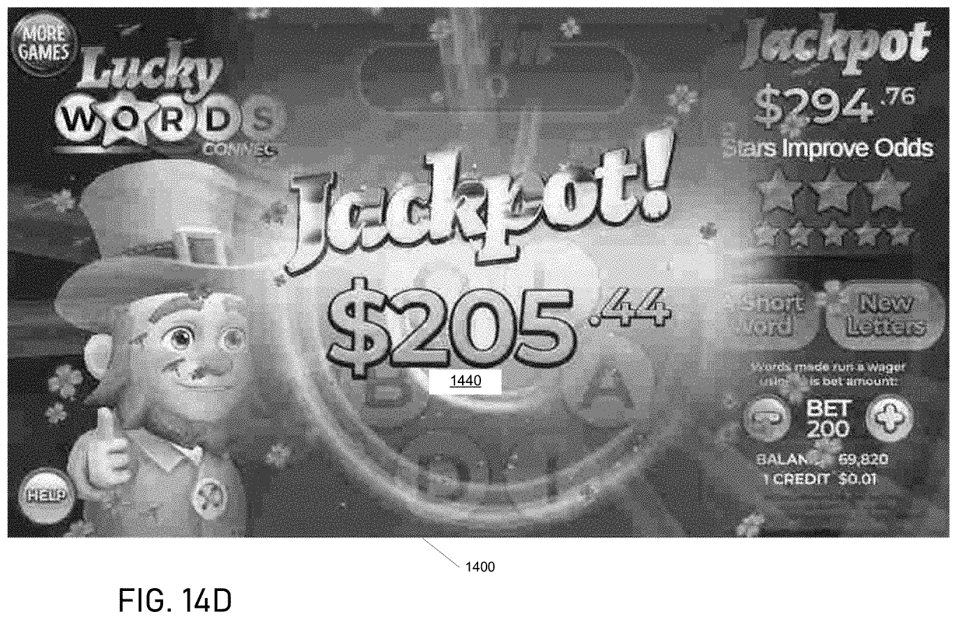

FIGS. 14A to 14D illustrate a user interface 1400 of an interactive application of a continuous multivariate wagering system in accordance with various embodiments of the invention. Referring to FIG. 14A, in operation, while the player continues gameplay, the system generates one or more stochastic elements and uses those stochastic elements to randomly select a set of symbols, such as symbols 1402a, 1402b, 1402c, 1402d, 1402e, and 1402f, to be used as resources in an interactive application and updates the user interface 1400 display of the interactive application to display the set of symbols. The system detects the player's interaction in connecting symbols of the set of symbols to attempt to create valid sequences of symbols as indicated by dashed line segments 1403. If no connections are detected, the system continues to detect player interactions. If symbol connections are detected the system updates the user interface and determines if the connected sequence of symbols is a valid sequence of symbols as indicated by the symbol sequence 1404. If the system detects an invalid or incomplete sequence of symbols, the system continues to detect player interactions. If the system detects a valid sequence of symbols, the system accumulates a connected symbol count based on the number of symbols that were connected in the sequence as indicated by icon 1405. The system generates additional stochastic elements to execute a wager and generate a chance-based award based (as indicated by won credit display 1409) on the length of the valid sequence (as indicated by the multiplier fields 1407a, 1407b, 1407c, 1407d, 1407e, and 1407f) and a commitment of credits to the wager. In addition, in some embodiments, the system generates additional stochastic elements to execute a wager and generate 1318 an additional chance-based award based on the accumulated connected symbol count 1406 and a commitment of credits to the wager. If the system detects that the accumulated connected symbol count has reached a specified symbol count associated with the randomly selected symbol set, the system generates one or more additional stochastic elements and uses them to randomly select a new symbol set for display to the player and gameplay continues. If the system does not detect that the specified symbol count has been reached, the system detects if the player is requesting a new symbol set as indicated by icon 1408. If so, the system generates one or more additional stochastic elements and uses them to randomly select a new set of symbols for display to the player and gameplay continues. If the system does not detect that the player is requesting a new symbol set, the system continues to detect player interactions.

In some embodiments, the player can request an autocomplete that will automatically find a short sequence of symbols that will trigger the execution of a wager as indicated by icon 1410.

Referring now to FIG. 14B, while the player continues gameplay, the system generates one or more stochastic elements and uses those stochastic elements to randomly select a set of symbols, such as symbols 1420a, 1420b, 1420c, 1420d, 1420e, and 1420f, to be used as resources in an interactive application and updates the user interface 1400 display of the interactive application to display the set of symbols. The system detects the player's interaction in connecting symbols of the set of symbols to attempt to create valid sequences of symbols as indicated by dashed line segments 1403. If the system detects an invalid or incomplete sequence of symbols, such as symbol sequence 1422, the system continues to detect player interactions without executing any wagers.

Referring to FIG. 14C, while the player continues gameplay, the system generates one or more stochastic elements and uses those stochastic elements to randomly select a set of symbols, such as symbols 1430a, 1430b, 1430c, 1430d, 1430e, and 1430f, to be used as resources in an interactive application and updates the user interface 1400 display of the interactive application to display the set of symbols. The system detects the player's interaction in connecting symbols of the set of symbols to attempt to create valid sequences of symbols as indicated by dashed line segments. If the system detects a valid sequence of symbols, the system accumulates a connected symbol count based on the number of symbols that were connected in the sequence. The system generates additional stochastic elements to execute a wager and generate a chance-based award based on the length of the valid sequence 1432.

Referring now to FIG. 14D, in operation, while the player continues gameplay, the system accumulates a connected symbol count based on the number of symbols that were connected in the sequence. The system generates additional stochastic elements to execute a wager and generate an additional chance-based award 1440 based on the accumulated connected symbol count and a commitment of credits to the wager.

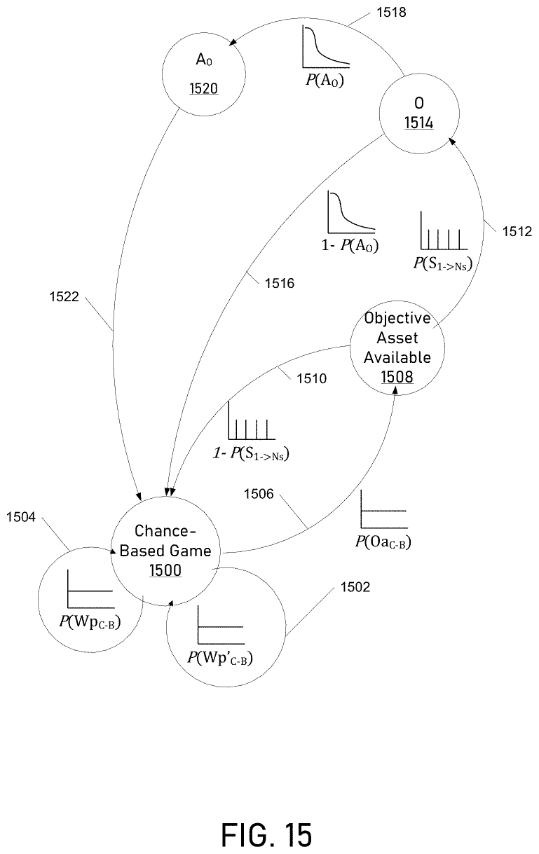

FIG. 15 is another state diagram illustrating another process of a system for continuous multivariate wagering in accordance with various embodiments of the invention. In the process, the system for continuous multivariate wagering presents 1500 a chance-based game to a player. The chance-based game includes one or more specified wagering propositions, as indicated by system stochastic transition P(Wp_{C-B}) in accordance which one or more chance-based outcomes are determined during gameplay and awarded to the player as described herein. The chance-based outcomes include awards of credits as well as awards of objective assets that are used by the player in playing an interactive game in conjunction with the chance-based game. If the system determines to award the player an objective asset, as indicated by chance-based transition 1506 with probability P(Oa_{C-B}), the system transitions to an objective asset available state 1508.

While the system is in the objective asset available state 1508, the player may select to utilize the asset to achieve an objective in the interactive game. If the system detects that the player does not select to attempt to achieve the objective, the system transitions, as indicated by interactive stochastic event transition 1-P(S_{1->Ns}) 1510, back to the chance-based game state and continues to present the wagering proposition to the player within the context of the chance-based game as indicated by system stochastic event transition P(Wp_{B-C}).

If the system detects that the player has selected to attempt to achieve the objective, the system transitions, as indicated by interactive stochastic event transition 1-P P(S_{->Ns}) 1512 to objective state O 1514 and presents the objective to the player within the context of an interactive game. If the system detects that the player successfully achieves the objective, the system transitions, as indicated by interactive stochastic event transition P(Ao) 1518 to an objective achievement state Ao 1520 and determines a modified specified wagering proposition and then the system transitions 1522 back to the chance-based game state. In the chance-based game state, the system presents to the player the modified specified wagering proposition, as indicated by system stochastic transition P(Wp′_{C-B}) 1502, within the context of the chance-based game as described herein.

If the system detects that the player fails to achieve the objective, the system transitions, as indicated by interactive stochastic event transition 1-P(Ao) 1516, to the chance-based game state. In the chance-based game state, the system presents to the player the specified wagering proposition, as indicated by system stochastic transition P(Wp_{C-B}) 1504, within the context of the chance-based game as described herein.

In an example embodiment, the chance-based game is a reel slot game wherein stochastic elements in the form of reel symbols are randomly determined and displayed to the player in form of one or more reels. If specified winning combinations of symbols are determined then the system awards a chance-based outcome in the form of an award of credits to the player. A specified wagering proposition includes a lookup table of symbols and associated chance-based outcomes used in conjunction with a randomly generated stochastic element in the form of a random number used as an index into the lookup table. A modified specified wagering proposition may be weighted in favor of the player by adjusting the table entries such that winning combinations of symbols are more likely to be determined, thus increasing the return to player. Alternatively, the modified specified wagering proposition may be weighted to disfavor the player by adjusting the table entries such that winning combinations of symbols are less likely to be determined, thus decreasing the return to player. In some embodiments, a favorable wagering proposition is communicated to the player as awarding the player special or wild symbols or the like.

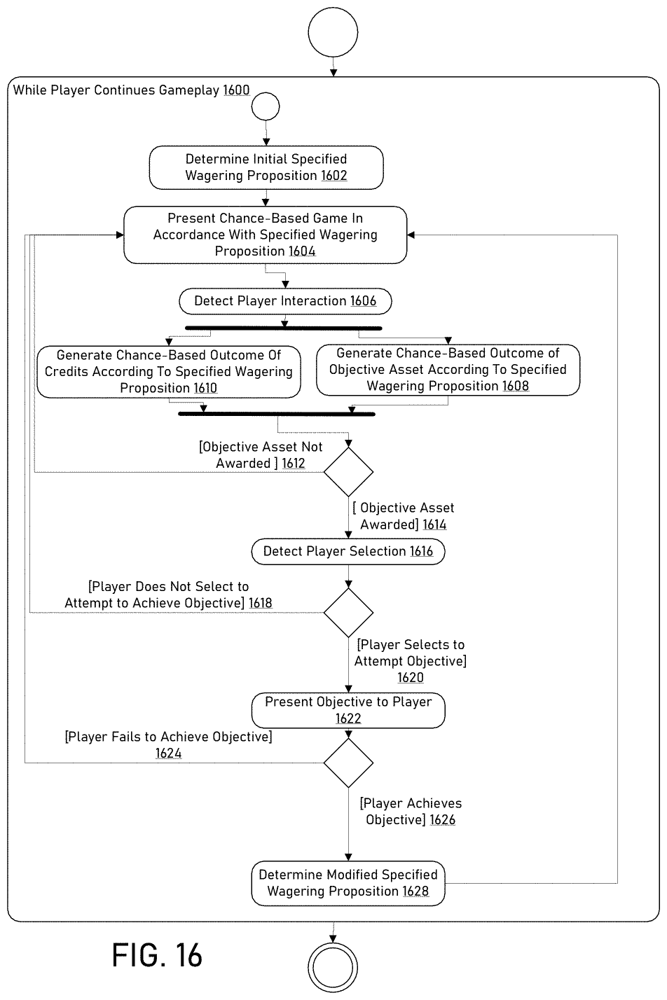

FIG. 16 is another activity diagram illustrating another process of a system for continuous multivariate wagering in accordance with various embodiments of the invention. In operation, while the player continues gameplay 1600, the system for continuous multivariate wagering presents 1604 a chance-based game to a player within a user interface of an interactive application as described herein. The system for continuous multivariate wagering determines 1602 an initial specified wagering proposition for the chance-based game. The chance-based game has a specified wagering proposition in accordance with which chance-based outcomes are determined during gameplay and awarded to the player as described herein. The chance-based outcomes include chance-based outcomes in the form of credits awarded to a player as well as chance-based outcomes in the form of objective assets that the player may use to achieve an objective in a conjunctive interactive game. The system detects 1606 player interactions with the chance-based game and in response generates 1610 one or more chance-based outcomes of credits in accordance with the specified wagering proposition as described herein. In addition, the system generates 1608 chance-based outcomes in the form of objective assets according to the specified wagering proposition. If no objective assets are awarded 1612 to the player, the system continues by presenting 1604 the chance-based game to the player. If an objective asset is awarded to the player 1614, the system detects 1616 a player selection of whether or not to attempt to achieve an objective in an interactive game using the objective asset. If the player does not select to attempt to achieve the objective 1618, the system continues to present 1604 the chance-based game to the player. If the player selects to attempt the objective 1620, the system presents 1622 the objective to the player within a context of the interactive game. If the system detects that the player fails to achieve the objective 1624, the system continues by presenting 1604 the chance-based game to the player. If the system detects that the player achieves the objective 1626, the system determines a modified specified wagering proposition 1628 and presents 1604 the chance-based game to the player in accordance with the specified wagering proposition as modified by the system.

In an example embodiment, the chance-based game is a reel slot game wherein stochastic elements in the form of reel symbols are randomly determined and displayed to the player in form of one or more reels. If specified winning combinations of symbols are determined then the system awards a chance-based outcome in the form of an award of credits to the player. A specified wagering proposition includes a lookup table of symbols and associated chance-based outcomes used in conjunction with a randomly generated stochastic element in the form of a random number used as an index into the lookup table. A modified specified wagering proposition may be weighted in favor of the player by adjusting the table entries such that winning combinations of symbols are more likely to be determined, thus increasing the return to player. Alternatively, the modified specified wagering proposition may be weighted to disfavor the player by adjusting the table entries such that winning combinations of symbols are less likely to be determined, thus decreasing the return to player. In some embodiments, a favorable modified wagering proposition is communicated to the player as awarding the player special or wild symbols or the like.

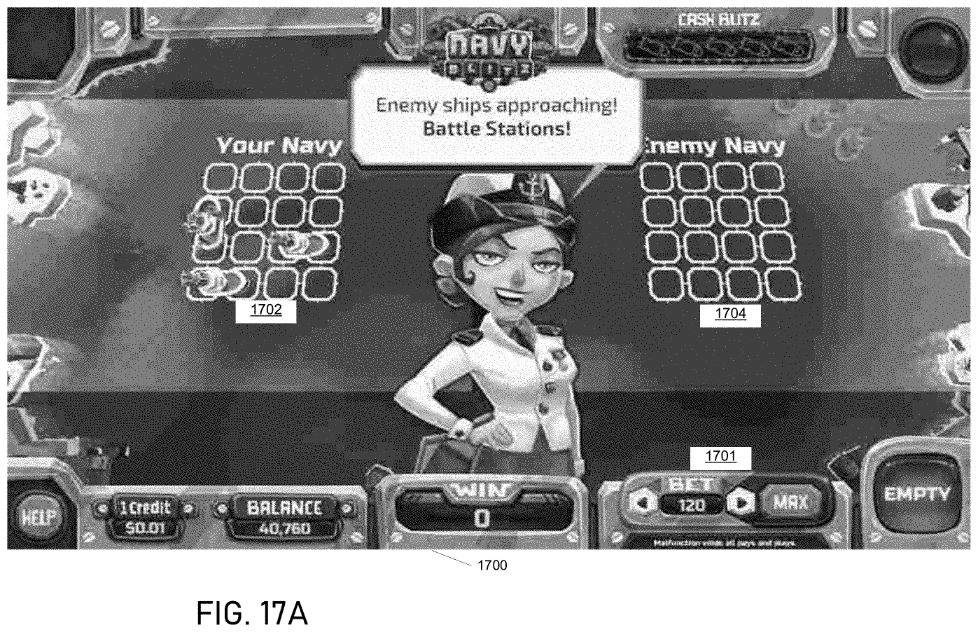

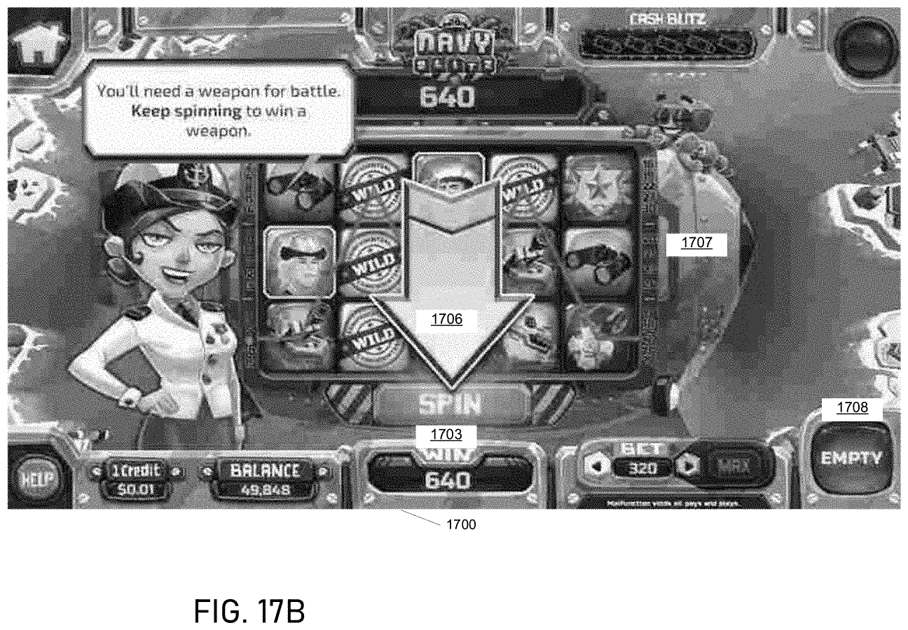

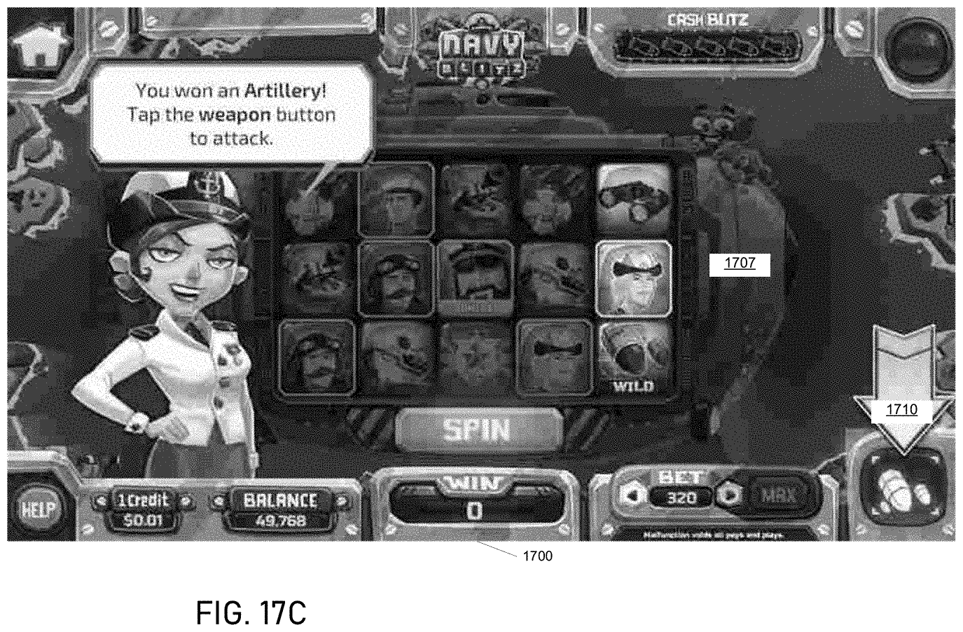

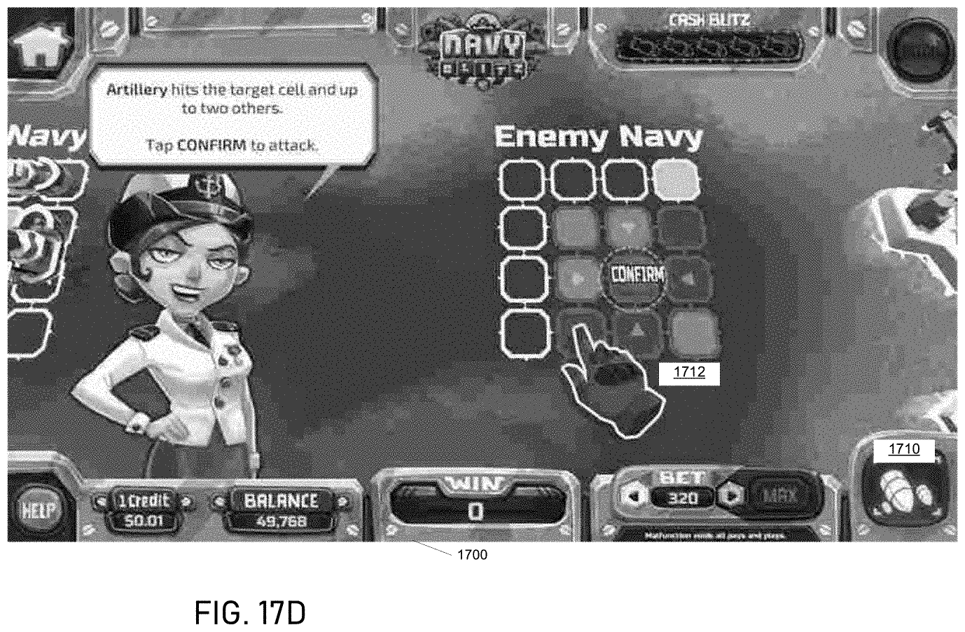

FIG. 17A to 17D illustrate a user interface 1700 of a system for continuous multivariate wagering in accordance with various embodiments of the invention.

Referring now to FIG. 17A, In the various embodiments, a chance-based game in the form of a reel slot machine is presented in conjunction with an interactive game that is a form of the game of battleship having two or more grids 1702 and 1704. In operation, while the player continues gameplay, the system for continuous multivariate wagering presents a chance-based game 1701 to a player within a user interface of an interactive application as described herein. The system for continuous multivariate wagering determines an initial specified wagering proposition for the chance-based game. The chance-based game has a specified wagering proposition in accordance with which chance-based outcomes are determined during gameplay and awarded to the player as described herein. The chance-based outcomes include chance-based outcomes in the form of credits awarded to a player as well as chance-based outcomes in the form of objective assets that the player may use to achieve an objective in a conjunctive interactive game.

Referring now to FIG. 17B, the system detects player interactions 1706 with the chance-based game 1707 and in response generates one or more chance-based outcomes of credits 1703 in accordance with the specified wagering proposition as described herein. In addition, the system generates chance-based outcomes 1708 in the form of objective assets according to the specified wagering proposition. If no objective assets are awarded to the player, the system continues by presenting the chance-based game to the player.

Referring now to FIG. 17C, if an objective asset is awarded to the player 1710, the system detects a player selection of whether or not to attempt to achieve an objective in an interactive game using the objective asset. If the player does not select to attempt to achieve the objective, the system continues to present the chance-based game 1707 to the player.

Referring now to FIG. 17D, if the player selects to attempt the objective, the system presents the objective to the player within a context of the interactive game 1712. If the system detects that the player fails to achieve the objective, the system continues by presenting the chance-based game to the player. If the system detects that the player achieves the objective, the system determines a modified specified wagering proposition and presents the chance-based game to the player in accordance with the specified wagering proposition as modified by the system as described herein.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An electronic gaming machine for performing a continuous multivariate wagering process, comprising:
an interactive controller constructed to:
receive a stochastic element of a multivariate wagering process from a process controller;
generate an interactive user interface including interactive elements using the stochastic element;
detect player interactions of a player with the interactive elements of the interactive user interface;
determine an interactive intermediate state of the continuous multivariate wagering process based on the player interactions; and
communicate the interactive intermediate state to the process controller; and
the process controller operatively connected to the interactive controller, wherein the process controller includes a random number generator, and wherein the process controller is constructed to:
generate the stochastic element using the random number generator;
determine a system intermediate state using the stochastic element;
communicate the stochastic element to the interactive controller;
receive the interactive intermediate state from the interactive controller; and
determine an award state based on the interactive intermediate state and the system intermediate state.

2. The electronic gaming machine for performing the continuous multivariate wagering process of claim 1, wherein the interactive controller and the process controller are constructed from the same device.

3. The electronic gaming machine for performing the continuous multivariate wagering process of claim 1, wherein the process controller is operatively connected to the interactive controller using a communication link.

4. The electronic gaming machine for performing the continuous multivariate wagering process of claim 1, further comprising:
an enclosure constructed to mount:
a user input device operatively connected to the interactive controller;
a user output device operatively connected to the interactive controller;
a credit input device operatively connected to the credit processing subcontroller; and
a credit output device operatively connected to the credit processing subcontroller,
wherein the process controller is further constructed to:
communicate with the credit input device to receive a credit input;
credit a credit meter with credits based on the incoming credit data;
determine a wagering outcome of the multivariate wagering process using the award state;
update the credit meter based on the wagering outcome; and
communicate with the credit output device to generate a credit output based on credits transferred off of the credit meter.

5. An electronic gaming machine for performing a continuous multivariate wagering process, comprising:
an enclosure constructed to mount:
a user input device;
a user output device;
a credit input device; and
a credit output device;
a random number generator;
at least one processor operatively connected to the user input device, the user output device, the credit input device, and the credit output device; and
a memory operatively connected to the at least one processor, the memory storing processor executable instructions that when executed by the processor cause the processor to:
communicate with the credit input device to receive a credit input;
credit a credit meter with credits based on the credit data;
generate a random number from the random number generator;
generate a stochastic component using the random number;
generate a stochastic element of the continuous multivariate wagering process using the stochastic component;
generate an interactive user interface of the continuous multivariate wagering process based on the stochastic component;
present the interactive user interface to a player using the user output device;
detect player interactions with the interactive user interface using the user input device;
determine an award state of the continuous multivariate wagering process based on the player interactions and the stochastic element;
determine a wagering outcome for the multivariate wagering process using the award state;
update the credit meter based on the wagering outcome; and
communicate with the credit output device to generate a credit output based on credits transferred off of the credit meter.

6. A distributed gaming system for performing a continuous multivariate wagering process, comprising:
an interactive controller constructed to:
receive a stochastic element of a multivariate wagering process from a process controller via a network;
generate an interactive user interface including interactive elements using the stochastic element;
detect player interactions of a player with the interactive elements of the interactive user interface;
determine an interactive intermediate state of the continuous multivariate wagering process based on the player interactions; and
communicate the interactive intermediate state to the process controller via the network; and
the process controller operatively connected to the interactive controller via the network, wherein the process controller includes a random number generator, and wherein the process controller is constructed to:
generate the stochastic element using the random number generator;
determine a system intermediate state using the stochastic element;
communicate the stochastic element to the interactive controller via the network;
receive the interactive intermediate state from the interactive controller via the network; and
determine an award state based on the interactive intermediate state and the system intermediate state.
